(19) United States
(12) Patent Application Publication
(10) Pub. No.: US 2025/0277730 A1
(43) Pub. Date: Sep. 4, 2025

(54) RAMAN-based method for the differentiation of AAV particle serotype and AAV particle loading status

(71) Applicant: Hoffmann-La Roche Inc., Little Falls, NJ (US)

(72) Inventors: Oliver POPP, Penzberg (DE); Michaela POTH, Geretsried (DE); Frederik SCHROETER, Penzberg (DE)

(73) Assignee: Hoffmann-La Roche Inc., Little Falls, NJ (US)

(21) Appl. No.: 18/956,931

(22) Filed: Nov. 22, 2024

Related U.S. Application Data
(63) Continuation of application No. PCT/EP2023/063235, filed on May 17, 2023.

(30) Foreign Application Priority Data
May 23, 2022 (EP) 22174776.9

(51) Int. Cl. G01N 15/1434

(52) U.S. Cl. CPC G01N 15/1434

(57) ABSTRACT

Herein is reported a method for determining in an aqueous sample using RAMAN spectroscopy viral particles with encapsidated nucleic acids comprising the steps of providing a sample and irradiating the sample with a light source; measuring the total intensity of RAMAN scattered light of each one of a first plurality of pre-selected wavenumbers and/or wavenumber ranges to obtain a first data set for the sample; performing a first set of mathematical data processing steps on the first data set; and determining the viral particles with encapsidated nucleic acid in the sample based upon the output of the first set of mathematical data processing steps, wherein the first set of mathematical data processing steps comprises a principal component analysis and the determining is based on the first principal component.

The current invention is in the field of analytical methods. In more detail, herein is reported a method for determining the AAV particle serotype and AAV particle loading status using RAMAN spectroscopy in combination with a classification or regression method, such as principal component analysis. With the method according to the current invention, different AAV particle serotypes as well as their loading status can be distinguished.

### BACKGROUND OF THE INVENTION

With their good safety profile, high therapeutic efficacy and the possibility of target specific engineering, adeno-associated virus (AAV) particles are commonly used as gene transfer vehicles for research and in clinical approaches. For recombinant production, accurate and robust analytical methods for viral vector characterization are required. Commonly, vector genome titration is performed by droplet digital PCR (ddPCR), which is a method for absolute quantification of nucleic acids. These methods are sensitive and specific, but laborious, costly and time demanding.

RAMAN spectroscopy is a powerful analytical approach to determine the vibrational modes of molecule bonds. RAMAN spectroscopy is commonly used in chemistry to provide a structural fingerprint by which molecules can be identified. Given the technical nature of this method, Raman spectroscopy can be applied fast and non-invasively on various Raman active samples not only for identification but also for quantification purposes. Furthermore, state-of-the-art chemometric and statistical data analysis approaches allow for multi-attribute RAMAN analysis of different compounds present in one common sample.

RAMAN spectroscopy, especially surface-enhanced RAMAN spectroscopy (SERS) as well as tip-enhanced RAMAN spectroscopy (TERS), has been applied for diverse viral diagnostic approaches in the recent past to clinical diagnostic and food quality insurance applications (Hermann, P., et al., The Analyst 136 (2011) 1148). Most approaches focused on the detection and quantification of specific viral contaminants and identification of viral infected cells (Gogone, I.C.V.P., et al. Spectrochim. Acta A 249 (2021) 119336; Moor, K., et al., J. Biomed. Optics 23 (2018) 097001). However, these sensitive RAMAN approaches often require nanoparticles conjugated to a substance capable of binding specifically to a viral antigen for the analysis, which induces test comparability and robustness challenges.

WO 2020/136376 discloses methods for determining viral titer using RAMAN spectroscopy based on a partial least squares analysis of the total intensity of RAMAN scattered light within each one of a plurality of wavenumber ranges to obtain a wavenumber intensity data set for the sample, wherein the plurality of wavenumber ranges are pre-selected and are characteristic of the virus in the sample.

WO 2022/003359 discloses methods for analyzing viruses using RAMAN spectroscopy wherein a first determination of the viral nucleic acid content of a sample, which is based upon the output of mathematical data processing steps performed on the total intensity of RAMAN scattered light within each one of a first plurality of wavenumber ranges, which are pre-selected and are characteristic of viral nucleic acids in the sample, is combined with a second determination of the content of viruses in the sample, which is based upon the output of mathematical data processing steps performed on the total intensity of RAMAN scattered light within each one of a second plurality of wavenumber ranges, which are pre-selected and are characteristic of one or more viral structural molecules of the virus in the sample. Thus, this document discloses a determination of the full/empty ratio that is based on two subsequent measurements in combination with the respective data analytical workflows, i.e. the ratio is calculated based on the outcome of both (two) measurements.

U.S. Pat. No. 6,040,191 discloses a RAMAN spectroscopic method for determining the ligand binding capacity of biologicals. Said method is a non-destructive process for determining capability of a test biological to bond with at least one ligand. Thus, this document is focused on determining the ligand binding capacity of biologicals.

US 2009/086201 discloses surface enhanced RAMAN spectroscopy (SERS) systems for the detection of viruses and methods of use thereof. Said method is a method of detecting at least one biomolecule in a sample comprising the attaching at least one first biomolecule to an array of nanorods on a substrate and the measuring of a surface enhances RAMAN spectroscopy (SERS) spectrum.

FR 3 109 819 discloses a method for detecting the presence of a pathogen in a biological fluid based on surface enhanced RAMAN spectroscopy (SERS) by contacting said sample with non-magnetic metal nanoparticles and depositing said solution or said suspension on a support.

Hermann et al. disclose the evaluation of tip-enhanced RAMAN spectroscopy for characterizing different virus strains (Analyst 136 (2011) 1148-1152). They outline that optical techniques like confocal RAMAN spectroscopy have proven to be fast, non-destructive and highly sensitive for chemical and biological analysis, allowing also in vivo investigations of single bacterial cells. As a drawback, they summarize that the detection of small biological structures like single virus particles requires additionally an improved spatial resolution and a significantly higher sensitivity. A solution thereto is disclosed to be tip-enhanced RAMAN spectroscopy, which is an analytical technique that combines the advantages of atomic force microscopy (AFM) or scanning tunneling microscopy (STM) with SERS.

Huang et al. disclose RAMAN spectroscopy for virus detection and the implementation of unorthodox food safety (Trends Food Sci. Technol. 116 (2021) 525-532). Therein reference is made to Thomas (Appl. Spectrosc. 30 (1976) 483-494), who surveyed the constitutional RNA, DNA, and proteins of viruses from the collected RAMAN spectra and found that the RAMAN signals of viruses are similar for the most part, making it hard to highlight the differences and statistical analysis of the spectra is to be applied to overcome these problem.

### SUMMARY OF THE INVENTION

Herein is reported a method for non-invasive, fast and efficient analysis of bioprocess-relevant AAV samples using RAMAN spectroscopy, i.e. micro RAMAN spectroscopy.

The current invention is based, at least on part, on the finding that RAMAN spectroscopy in combination with statistical and machine learning/deep learning techniques can be used i) to detect low concentrations of full as well as empty particles of different AAV serotype capsids in aqueous buffer solutions, ii) to differentiate between full and empty particles in capsid samples, and iii) to differentiate between particles with capsids of different serotype.

In further more detail, the current invention is based, at least on part, on the finding that conventional micro RAMAN spectroscopy in combination with principal component data analysis (PCA) can be used i) to detect low concentrations of full particles of the AAV2 and AAV8 serotype in aqueous buffer solutions, ii) to differentiate between full and empty particles in samples, and iii) to differentiate between particles of different serotype.

It has been found that with the method according to the current invention AAV particles of different serotypes present in a sample, such as, e.g., AAV2, AAV5, AAV8 and AAV9, can be distinguished. Furthermore, the method according to the current invention allows for the direct determination of the loading status of AAV particles, i.e. if the particles comprise encapsidated DNA (i.e. are full particles) or do not comprise encapsidated DNA (i.e. are empty particles).

The method according to the current invention is suitable for fast, non-invasive analysis of AAV particle containing samples, for, e.g., in-process control, quality assurance and control and (real-time) release analytics.

The current invention is directed to a method for determining in an aqueous sample using RAMAN spectroscopy viral particles with encapsidated nucleic acid comprising the steps of:
(a) providing a sample and irradiating the sample with a light source;
(b) (i) measuring the total intensity of RAMAN scattered light of each one of a first plurality of pre-selected wavenumbers and/or wavenumber ranges to obtain a first data set for the sample;
   (ii) performing a first set of mathematical data processing steps on the first data set; and
(c) determining the viral particles with encapsidated nucleic acid in the sample based upon the output of the first set of mathematical data processing steps.

The determination in the method according to the current invention can be done qualitatively as well as quantitatively. In case of a quantitative determination, the number of viral particles with encapsidated nucleic acid is determined. The total number of viral particles can be determined by any method known in the art. The difference between the total number of particles and the number of particles with encapsidated nucleic acid is the number of particles without encapsidated nucleic acid. Thus, this number can be likewise determined based on the method according to the current invention.

It has to be pointed out that in the method according to the current invention no ligand binding to a matrix is required. That is no binary classification (presence/absence) is comprised in the method according to the current invention. The method according to the current invention uses micro RAMAN spectroscopy

It has further to be pointed out that in the method according to the current invention a single measurement is used for the determination. Especially and surprisingly, it has been found that this allows for the differentiation between full and empty AAV particles.

It has further to be pointed out that in the method according to the current invention no tagging or labelling of the AAV particles is required.

The current invention encompasses the following embodiments:
1. A method for determining in an aqueous sample using RAMAN spectroscopy viral particles with encapsidated nucleic acid comprising the steps of:
   (a) providing a sample and irradiating the sample with a light source;
   (b) (i) measuring the total intensity of RAMAN scattered light of the sample or of at least each one of a first plurality of pre-selected wavenumbers and/or wavenumber ranges to obtain a first data set for the sample;
      (ii) performing a first set of mathematical data processing steps on the first data set; and
   (c) determining the viral particles with encapsidated nucleic acid in the sample based upon the output of the first set of mathematical data processing steps.
2. A method for determining in an aqueous sample using RAMAN spectroscopy viral particles without encapsidated nucleic acid comprising the steps of:
   (a) providing a sample and irradiating the sample with a light source;
   (b) (i) measuring the total intensity of RAMAN scattered light of the sample or of at least each one of a first plurality of pre-selected wavenumbers and/or wavenumber ranges to obtain a first data set for the sample;
      (ii) performing a first set of mathematical data processing steps on the first data set; and
   (c) determining the viral particles without encapsidated nucleic acid in the sample based upon the output of the first set of mathematical data processing steps.
3. The method according to any one of embodiments 1 to 2, wherein the first set of mathematical data processing steps on the first data set is a classification or regression method.
4. The method according to any one of embodiments 1 to 3, wherein the first set of mathematical data processing steps on the first data set is an artificial neuronal network or a decision-tree-based model or principal component analysis, preferably principal component analysis.
5. The method according to any one of embodiments 1 to 4, wherein the first set of mathematical data processing steps on the first data set is selected from the group consisting of principal component analysis (PCA), non-negative matrix factorization (NMF), linear discriminant analysis (LDA), generalized discriminant analysis (GDA), canonical correlation analysis (CCA), autoencoder, T-distributed stochastic neighbor embedding (t-SNE), uniform manifold approximation and projection (UMAP), K-nearest neighbors algorithm (k-NN), kernel or graph-based kernel PCA, and low-dimensional embedding using PCA, LDA, CCA, or NMF techniques as a pre-processing step followed by clustering by K-NN.
6. The method according to any one of embodiments 1 to 5, wherein the first set of mathematical data processing steps on the first data set is principal component analysis and the viral particles with or without encapsidated nucleic acid are determined based upon the first principal component.
7. The method according to any one of embodiments 1 to 6, wherein the step (i) comprises
   (alpha) measuring the total intensity of RAMAN scattered light of the sample,
   (beta) elimination of wavenumbers outside of a first plurality of pre-selected wavenumbers and/or wavenumber ranges,
   (gamma) generating the 1st deviation of the data function, and
   (delta) normalizing the spectra,
   to obtain a first data set for the sample.
8. The method according to embodiment 7, wherein the generating the 1st deviation of the data function is by applying a Savitzky-Golay (SG) filter.
9. The method according to any one of embodiments 1 to 8, wherein the RAMAN scattered light is determined using a confocal RAMAN microscope or micro RAMAN spectroscopic device.
10. The method according to any one of embodiments 1 to 9, wherein the sample has a volume of 5 μL to 1000 μL.
11. The method according to any one of embodiments 1 to 10, wherein the sample has a volume of 20 μL to 250 μL.
12. The method according to any one of embodiments 1 to 11, wherein the sample has a volume of about 200 μL.
13. The method according to any one of embodiments 1 to 11, wherein the sample has a volume of about 30 to 50 μL.
14. The method according to any one of embodiments 1 to 13, wherein the sample is a crude sample/is not pre-treated.
15. The method according to any one of embodiments 1 to 14, wherein the viral particle is a parvoviral particle.
16. The method according to any one of embodiments 1 to 15, wherein the encapsidated nucleic acid is single stranded DNA.
17. The method according to any one of embodiments 1 to 16, wherein the viral particle is an adeno-associated viral particle.
18. The method according to any one of embodiments 1 to 17, wherein the viral particle is an adeno-associated viral particle of the serotype 2 or 5 or 8 or 9.
19. The method according to any one of embodiments 1 to 18, wherein the light source has a wavelength of about 532 nm or about 785 nm.
20. The method according to any one of embodiments 1 to 19, wherein the viral particle is an AAV particle of the serotype 2 and the light source has a wavelength of about 532 nm or about 785 nm.
21. The method according to any one of embodiments 1 to 19, wherein the viral particle is an AAV particle of the serotype 8 and the light source has a wavelength of about 785 nm.
22. The method according to any one of embodiments 1 to 21, wherein the first plurality of pre-selected wavenumbers and/or wavenumber ranges is consisting of DNA/RNA/protein specific nucleotide bond deformation and the amide I bond stretches.
23. The method according to any one of embodiments 1 to 22, wherein the first plurality of pre-selected wavenumbers and/or wavenumber ranges is consisting of 489 to 728 cm-1 or/and 1645 to 1680 cm-1.
24. The method according to any one of embodiments 1 to 23, wherein the viral particle is an AAV2 viral particle.
25. The method according to any one of embodiments 1 to 21, wherein the first plurality of pre-selected wavenumbers and/or wavenumber ranges is consisting of protein-specific vibrations of the S-S Cys bridge, Tyr-specific vibrations, C-C stretch in beta-sheet, Phe-specific vibrations, or/and the amide I bond stretches.
26. The method according to any one of embodiments 1 to 21 and 25, wherein the first plurality of pre-selected wavenumbers and/or wavenumber ranges is consisting of one or more or all of 551 cm-1, 645 cm-1, 1000 cm-1, 1003 cm-1, 1530-1630 cm-1, or/and 1645 to 1680 cm-1.
27. The method according to any one of embodiments 1 to 21 and 25 to 26, wherein the viral particle is an AAV8 viral particle.
28. The method according to any one of embodiments 1 to 21, wherein the first plurality of pre-selected wavenumbers and/or wavenumber ranges is consisting of protein- and nucleic acid-specific vibrations of the S-S Cys bridge, Tyr-specific vibrations, nucleotide ring deformation and stretching, A/G and U/C ring vibrations, Phe-specific vibrations, or/and the amide I bond stretches.
29. The method according to any one of embodiments 1 to 21 and 28, wherein the first plurality of pre-selected wavenumbers and/or wavenumber ranges is consisting of one or more or all of 551 cm-1, 645 cm-1, 631-787 cm-1, 1425 1485 cm-1, 1003 cm-1, or/and 1645 to 1680 cm-1.
30. The method according to any one of embodiments 1 to 21 and 28 to 29, wherein the viral particle is an AAV2 particle and the sample further comprises AAV2 viral particles without encapsidated nucleic acid.
31. The method according to any one of embodiments 1 to 21, wherein the first plurality of pre-selected wavenumbers and/or wavenumber ranges is consisting of protein-specific vibrations of the S-S Cys bridge, Tyr-specific vibrations, protein C-C stretch in helix structure, C-C stretch in beta-sheet, Phe-specific vibrations, or/and the amide I bond stretches.
32. The method according to any one of embodiments 1 to 21 and 31, wherein the first plurality of pre-selected wavenumbers and/or wavenumber ranges is consisting of one or more or all of 551 cm-1, 645 cm-1, 920-950 cm-1, 1000 cm-1, 1003 cm-1, 1530-1630 cm-1, or/and 1645 to 1680 cm-1.
33. The method according to any one of embodiments 1 to 21 and 31 to 32, wherein the viral particle is an AAV2 viral particle and the sample further comprises AAV8 viral particles with encapsidated nucleic acid.
34. The method according to any one of embodiments 1 to 21 and 31 to 32, wherein the viral particle is an AAV8 viral particle and the sample further comprises AAV2 viral particles with encapsidated nucleic acid.
35. The method according to any one of embodiments 1 to 21 and 31 to 32, wherein in step (c) the calculation is not conclusive as the sample comprises a mixture of AAV particles of different serotype.
36. The method according to any one of embodiments 1 to 35, wherein the first plurality of pre-selected wavenumbers and/or wavenumber ranges is consisting of one or more all at least all of 551 cm-1, 645 cm-1, 631-728 cm-1 or/and 1645-1680 cm-1.
37. The method according to any one of embodiments 1 to 21, wherein the first plurality of pre-selected wavenumbers and/or wavenumber ranges is consisting of V (S-S) disulfide in proteins, polysaccharides, DNA, Proteins vC-C alpha-helix, Amide III, RNA and Amide I vibrations/stretches.
38. The method according to any one of embodiments 1 to 21 and 37, wherein the first plurality of pre-selected wavenumbers is consisting of one or more or all of the RAMAN shifts of 530 cm-1, 565 cm-1, 665 cm-1, 725 cm-1, 785 cm-1, 850 cm-1, 936 cm-1, 1230 cm-1, 1244 cm-1, 1265 cm-1, or/and 1671 cm-1.
39. The method according to any one of embodiments 1 to 21 and 37 to 38, wherein the viral particle is an AAV2 viral particle.
40. The method according to any one of embodiments 1 to 21, wherein the first plurality of pre-selected wavenumbers and/or wavenumber ranges is consisting of polysaccharides, DNA, proteins vC-C beta-sheet, Phenylalanine, nucleic acids, RNA, Tyrosine and Amide I stretches.
41. The method according to any one of embodiments 1 to 21 and 40, wherein the first plurality of pre-selected wavenumbers is consisting of one or more or all of the RAMAN shifts of 460 cm-1, 670-785 cm-1, 985 cm-1, 1003 cm-1, 1080 cm-1, 1244 cm-1, 1613 cm-1, or/and 1671 cm-1.
42. The method according to any one of embodiments 1 to 21 and 40 to 41, wherein the viral particle is an AAV8 viral particle.
43. The method according to any one of embodiments 1 to 21, wherein the first plurality of pre-selected wavenumbers and/or wavenumber ranges is consisting of V (S-S) disulfide in proteins, polysaccharides, DNA, proteins vC-C beta-sheet, Phenylalanine, Amide III and Amide I stretches.
44. The method according to any one of embodiments 1 to 21 and 43, wherein the first plurality of pre-selected wavenumbers is consisting of one or more of all of the RAMAN shifts of 530 cm-1, 565 cm-1, 665 cm-1, 725 cm-1, 785 cm-1, 985 cm-1, 1003 cm-1, 1265 cm-1, or/and 1671 cm-1.
45. The method according to any one of embodiments 1 to 21 and 43 to 44, wherein the viral particle is an AAV2 particle and the sample further comprises AAV2 viral particles without encapsidated nucleic acid.
46. The method according to any one of embodiments 1 to 21, wherein the first plurality of pre-selected wavenumbers and/or wavenumber ranges is consisting of polysaccharides, DNA, proteins vC-C alpha-helix, proteins vC-C beta-sheet, Phenylalanine, nucleic acids, RNA, C—H vibration (proteins), Phenylalanine, proteins, Tyrosine and Amide I stretches.
47. The method according to any one of embodiments 1 to 21 and 46, wherein the first plurality of pre-selected wavenumbers is consisting of one or more or all of the RAMAN shifts of 460 cm-1, 565 cm-1, 665 cm-1, 750 cm-1, 825 cm-1, 855 cm-1, 936 cm-1, 985 cm-1, 1003 cm-1, 1080 cm-1, 1244 cm-1, 1450 cm-1, 1585 cm-1, 1613 cm-1, or/and 1671 cm-1.
48. The method according to any one of embodiments 1 to 21 and 46 to 47, wherein the viral particle is an AAV2 viral particle and the sample further comprises AAV8 viral particles with encapsidated nucleic acid.
49. The method according to any one of embodiments 1 to 21 and 46 to 47, wherein the viral particle is an AAV8 viral particle and the sample further comprises AAV2 viral particles with encapsidated nucleic acid.
50. The method according to any one of embodiments 1 to 21 and 46 to 49, wherein the first plurality of pre-selected wavenumbers is consisting of one or more or all of the RAMAN shifts of 1671 cm-1 and one or more of 565 cm-1, 665 cm-1, 785 cm-1, 985 cm-1, 1003 cm-1, or/and 1244 cm-1.
51. A method for determining in an aqueous sample using RAMAN spectroscopy viral particles without encapsidated nucleic acid comprising the steps of
   a) determining in the aqueous sample using RAMAN spectroscopy viral particles with encapsidated nucleic acid with a method according to any one of embodiments 1 to 50,
   b) determining the total number of viral particles in the aqueous sample,
   c) obtaining the number of viral particles without encapsidated nucleic acid by subtracting the number obtained in b) by the number obtained in a).
52. The method according to embodiment 51, wherein the total number of viral particles in the aqueous sample is determined by an enzyme linked immunosorbent assay.
53. The method according to any one of embodiments 1 to 52, wherein the method is for quantifying.
54. The method according to embodiment 53, wherein the quantifying is done by applying a statistical or machine learning/deep learning method from the group of methods consisting of partial least square (PLS), lasso, lasso-lars, ridge regression, elastic net, Huber regression, passive aggressive regression, Bayesian ridge regression, orthogonal matching pursuit, (artificial) neural networks (ANN), (nu) support vector regression, random forest regression, decision tree, XGBoost regression, gradient boosting regression, adaboost regression, autogluon, and autokeras on the RAMAN data.
55. Use of RAMAN spectroscopy in combination with mathematical analysis or mathematical processing of the total intensity of RAMAN scattered light of the sample or of at least each one of a first plurality of pre-selected wavenumbers and/or wavenumber ranges for the determination of viral particles with encapsidated nucleic acid in a sample.
56. Use of RAMAN spectroscopy in combination with mathematical analysis or mathematical processing of the total intensity of RAMAN scattered light of the sample or of at least each one of a first plurality of pre-selected wavenumbers and/or wavenumber ranges for the determination of viral particles without encapsidated nucleic acid in a sample.
57. The use according to any one of embodiments 55 to 56, wherein the mathematical analysis or mathematical processing is a classification or regression method.
58. The use according to any one of embodiments 55 to 57, wherein the mathematical analysis or mathematical processing is by an artificial neuronal network or a decision-tree-based model or principal component analysis.
59. The use according to any one of embodiments 55 to 58, wherein the mathematical analysis or mathematical processing is selected from the group consisting of principal component analysis (PCA), non-negative matrix factorization (NMF), linear discriminant analysis (LDA), generalized discriminant analysis (GDA), canonical correlation analysis (CCA), autoencoder, T-distributed stochastic neighbor embedding (t-SNE), uniform manifold approximation and projection (UMAP), K-nearest neighbors algorithm (k-NN), kernel or graph-based kernel PCA, and low-dimensional embedding using PCA, LDA, CCA, or NMF techniques as a pre-processing step followed by clustering by K-NN.
60. The use according to any one of embodiments 55 to 59, wherein the mathematical analysis or mathematical processing is by principal component analysis and the viral particles with or without encapsidated nucleic acid are determined based upon the first principal component.
61. The use according to any one of embodiments 55 to 60, wherein the use is for a real-time determination.
62. The use according to any one of embodiments 55 to 60, wherein the use is for a non-invasive determination.
63. The use according to any one of embodiments 55 to 60, wherein the use is for an in process control determination.
64. The use according to any one of embodiments 55 to 60, wherein the use is for quality assurance determination.
65. The use according to any one of embodiments 55 to 60, wherein the use is for analytical determination.
66. The use according to any one of embodiments 55 to 60, wherein the use is for quality control determination.
67. The use according to any one of embodiments 55 to 60, wherein the use is for release analytics determination.
68. The use according to any one of embodiments 55 to 67, wherein the principal component analysis encompasses
   (alpha) measuring the total intensity of RAMAN scattered light of the sample,
   (beta) elimination of wavenumbers outside of a first plurality of pre-selected wavenumbers and/or wavenumber ranges,
   (gamma) generating the 1st deviation of the data function, and
   (delta) normalizing the spectra.
69. The use according to embodiment 68, wherein he generating the 1st deviation of the data function is by applying a Savitzky-Golay filter.
70. The use according to any one of embodiments 55 to 69, wherein in the RAMAN spectroscopy RAMAN scattered light is determined using a confocal RAMAN microscope or micro RAMAN.
71. The use according to any one of embodiments 55 to 10, wherein the sample is a crude sample/is not pre-treated.
72. The use according to any one of embodiments 55 to 71, wherein the viral particle is a parvoviral particle.
73. The use according to any one of embodiments 55 to 72, wherein the encapsidated nucleic acid is single stranded DNA.
74. The use according to any one of embodiments 55 to 73, wherein the viral particle is an adeno-associated viral particle.
75. The use according to any one of embodiments 55 to 74, wherein the viral particle is an adeno-associated viral particle of the serotype 2 or 5 or 8 or 9.
76. The use according to any one of embodiments 55 to 75, wherein the RAMAN spectroscopy uses a wavelength of about 532 nm or about 785 nm.
77. The use according to any one of embodiments 55 to 76, wherein the viral particle is an AAV particle of the serotype 2 and the RAMAN spectroscopy uses a wavelength of about 532 nm or about 785 nm.
78. The use according to any one of embodiments 55 to 76, wherein the viral particle is an AAV particle of the serotype 8 and the RAMAN spectroscopy uses a wavelength of about 785 nm.
79. The use according to any one of embodiments 55 to 78, wherein the principal component analysis first plurality of pre-selected wavenumbers and/or wavenumber ranges is consisting of DNA/RNA/protein specific nucleotide bond deformation or/and the amide I bond stretches.
80. The use according to any one of embodiments 55 to 79, wherein the first plurality of pre-selected wavenumbers and/or wavenumber ranges is consisting of 489 to 728 cm-1 or/and 1645 to 1680 cm-1.
81. The use according to any one of embodiments 55 to 80, wherein the viral particle is an AAV2 viral particle.
82. The use according to any one of embodiments 55 to 78, wherein the first plurality of pre-selected wavenumbers and/or wavenumber ranges is consisting of protein-specific vibrations of the S-S Cys bridge, Tyr specific vibrations, C-C stretch in beta-sheet, Phe-specific vibrations, Tyr specific vibrations, or/and the amide I bond stretches.
83. The use according to any one of embodiments 55 to 78 and 82, wherein the first plurality of pre-selected wavenumbers and/or wavenumber ranges is consisting of one or more or all of 551 cm-1, 645 cm-1, 1000 cm-1, 1003 cm-1, 1530-1630 cm-1, or/and 1645 to 1680 cm-1.
84. The use according to any one of embodiments 55 to 78 and 82 to 83, wherein the viral particle is an AAV8 viral particle.
85. The use according to any one of embodiments 55 to 78, wherein the first plurality of pre-selected wavenumbers and/or wavenumber ranges is consisting of protein- and nucleic acid-specific vibrations of the S-S Cys bridge, Tyr specific vibrations, nucleotide ring deformation and stretching, A/G and U/C ring vibrations, Phe-specific vibrations, or/and the amide I bond stretches.
86. The use according to any one of embodiments 55 to 78 and 85, wherein the first plurality of pre-selected wavenumbers and/or wavenumber ranges is consisting of one or more or all of 551 cm-1, 645 cm-1, 631-787 cm-1, 1425-1485 cm-1, 1003 cm-1 and 1645 to 1680 cm-1.
87. The use according to any one of embodiments 55 to 78 and 85 to 86, wherein the viral particle is an AAV2 particle and the sample further comprises AAV2 viral particles without encapsidated nucleic acid.
88. The use according to any one of embodiments 55 to 78, wherein the first plurality of pre-selected wavenumbers and/or wavenumber ranges is consisting of protein-specific vibrations of the S-S Cys bridge, Tyr specific vibrations, protein C-C stretch in helix structure, C-C stretch in beta-sheet, Phe-specific vibrations, Tyr-specific vibrations, or/and the amide I bond stretches.
89. The use according to any one of embodiments 55 to 78 and 88, wherein the first plurality of pre-selected wavenumbers and/or wavenumber ranges is consisting of one or more or all of 551 cm-1, 645 cm-1, 920-950 cm-1, 1000 cm-1, 1003 cm-1, 1530-1630 cm-1, or/and 1645 to 1680 cm-1.
90. The use according to any one of embodiments 55 to 78 and 88 to 89, wherein the viral particle is an AAV2 viral particle and the sample further comprises AAV8 viral particles with encapsidated nucleic acid.
91. The use according to any one of embodiments 55 to 78 and 88 to 89, wherein the viral particle is an AAV8 viral particle and the sample further comprises AAV2 viral particles with encapsidated nucleic acid.
92. The use according to any one of embodiments 55 to 78 and 88 to 89, wherein in step (c) the calculation is not conclusive as the samples comprises a mixture of AAV particles of different serotype.
93. The use according to any one of embodiments 55 to 78, wherein the first plurality of pre-selected wavenumbers and/or wavenumber ranges is consisting at least of 551 cm-1, 645 cm-1, 631-728 cm-1 and 1645-1680 cm-1.
94. The use according to any one of embodiments 55 to 78, wherein the first plurality of pre-selected wavenumbers and/or wavenumber ranges is consisting of V (S-S) disulfide in proteins, polysaccharides, DNA, Proteins vC-C alpha-helix, Amide III, RNA or/and Amide I vibrations/stretches.
95. The use according to any one of embodiments 55 to 78 and 94, wherein the first plurality of pre-selected wavenumbers is consisting of the RAMAN shifts of one or more or all of 530 cm-1, 565 cm-1, 665 cm-1, 725 cm-1, 785 cm-1, 850 cm-1, 936 cm-1, 1230 cm-1, 1244 cm-1, 1265 cm-1 or/and 1671 cm-1.
96. The use according to any one of embodiments 55 to 78 and 94 to 95, wherein the viral particle is an AAV2 viral particle.
97. The use according to any one of embodiments 55 to 78, wherein the first plurality of pre-selected wavenumbers and/or wavenumber ranges is consisting of polysaccharides, DNA, proteins vC-C beta-sheet, Phenylalanine, nucleic acids, RNA, Tyrosine or/and Amide I stretches.
98. The use according to any one of embodiments 55 to 78 and 97, wherein the first plurality of pre-selected wavenumbers is consisting of the RAMAN shifts of one or more or all of 460 cm-1, 670-785 cm-1, 985 cm-1, 1003 cm-1, 1080 cm-1, 1244 cm-1, 1613 cm-1, and 1671 cm-1.
99. The use according to any one of embodiments 55 to 78 and 97 to 98, wherein the viral particle is an AAV8 viral particle.
100. The use according to any one of embodiments 55 to 78, wherein the first plurality of pre-selected wavenumbers and/or wavenumber ranges is consisting of V (S-S) disulfide in proteins, polysaccharides, DNA, proteins vC-C beta-sheet, Phenylalanine, Amide III and Amide I stretches.
101. The use according to any one of embodiments 55 to 78 and 100, wherein the first plurality of pre-selected wavenumbers is consisting of the RAMAN shifts of one or more or all of 530 cm-1, 565 cm-1, 665 cm-1, 725 cm-1, 785 cm-1, 985 cm-1, 1003 cm-1, 1265 cm-1 or/and 1671 cm-1.
102. The use according to any one of embodiments 55 to 78 and 100 to 101, wherein the viral particle is an AAV2 particle and the sample further comprises AAV2 viral particles without encapsidated nucleic acid.
103. The use according to any one of embodiments 55 to 78, wherein the first plurality of pre-selected wavenumbers and/or wavenumber ranges is consisting of polysaccharides, DNA, proteins vC-C alpha-helix, proteins vC-C beta-sheet, Phenylalanine, nucleic acids, RNA, C—H vibration (proteins), Phenylalanine, proteins, Tyrosine or/and Amide I stretches.
104. The use according to any one of embodiments 55 to 78 and 103, wherein the first plurality of pre-selected wavenumbers is consisting of the RAMAN shifts of one or more or all of 460 cm-1, 565 cm-1, 665 cm-1, 750 cm-1, 825 cm-1, 855 cm-1, 936 cm-1, 985 cm-1, 1003 cm-1, 1080 cm-1, 1244 cm-1, 1450 cm-1, 1585 cm-1, 1613 cm-1 or/and 1671 cm-1.
105. The use according to any one of embodiments 55 to 78 and 103 to 104, wherein the viral particle is an AAV2 viral particle and the sample further comprises AAV8 viral particles with encapsidated nucleic acid.
106. The use according to any one of embodiments 55 to 78 and 103 to 105, wherein the viral particle is an AAV8 viral particle and the sample further comprises AAV2 viral particles with encapsidated nucleic acid.
107. The use according to any one of embodiments 55 to 78 and 103 to 106, wherein the first plurality of pre-selected wavenumbers is consisting of the RAMAN shifts of one or more of 1671 cm-1 and one or more of 565 cm-1, 665 cm-1, 785 cm-1, 985 cm-1, 1003 cm-1 or/and 1244 cm-1.
108. The method according to any one of claims 1 to 54, wherein the determining is in solution.
108. The method according to any one of claims 1 to 54, wherein the viral particles are in solution.
110. The method according to any one of claims 1 to 54, wherein the viral particles are not immobilized or attached to a solid surface.
111. The method according to any one of claims 1 to 54 and 108 to 110, wherein the measuring as performed in step b (i) is the only RAMAN measuring in the method.
112. The method according to any one of claims 1 to 54 and 108 to 110, wherein the measuring as performed in step b (i) is the only measuring in the method.
113. The method according to any one of claims 1 to 54 and 108 to 112, wherein the viral particles are neither derivatized nor tagged nor labelled.
114. The method according to any one of claims 1 to 54 and 108 to 112, wherein the viral particles are non-derivatized viral particles or non-tagged viral particles or non-labelled viral particles.
115. The use according to any one of claims 55 to 107, wherein the determining is in solution.
116. The use according to any one of claims 55 to 107, wherein the viral particles are in solution.
117. The use according to any one of claims 55 to 107, wherein the viral particles are not immobilized or attached to a solid surface.
118. The use according to any one of claims 55 to 107 and 115 to 117, wherein the RAMAN spectroscopy is the only RAMAN measuring.
119. The use according to any one of claims 55 to 107 and 115 to 117, wherein the RAMAN spectroscopy is the only measuring.
120. The use according to any one of claims 55 to 107 and 115 to 119, wherein the viral particles are neither derivatized nor tagged nor labelled.
121. The use according to any one of claims 55 to 107 and 115 to 119, wherein the viral particle are non-derivatized viral particles or non-tagged viral particles or non-labelled viral particles.

### DETAILED DESCRIPTION OF EMBODIMENTS OF THE INVENTION

The current invention is based, at least on part, on the finding that conventional micro RAMAN spectroscopy in combination with principle component data analysis can be used i) to detect low concentrations of full AAV2 and AAV8 particles in aqueous buffer solutions, ii) to differentiate between full and empty AAV particles in samples, and iii) to differentiate between particles of different serotype.

### Definitions

Useful methods and techniques for carrying out the current invention are described in e.g. Ausubel, F. M. (ed.), Current Protocols in Molecular Biology, Volumes I to III (1997); Glover, N. D., and Hames, B. D., ed., DNA Cloning: A Practical Approach, Volumes I and II (1985), Oxford University Press; Freshney, R. I. (ed.), Animal Cell Culture—a practical approach, IRL Press Limited (1986); Watson, J. D., et al., Recombinant DNA, Second Edition, CHSL Press (1992); Winnacker, E. L., From Genes to Clones; N.Y., VCH Publishers (1987); Celis, J., ed., Cell Biology, Second Edition, Academic Press (1998); Freshney, R. I., Culture of Animal Cells: A Manual of Basic Technique, second edition, Alan R. Liss, Inc., N.Y. (1987).

It must be noted that as used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably.

The term “AAV helper functions” denotes AAV-derived coding sequences (proteins) which can be expressed to provide AAV gene products and AAV particles that, in turn, function in trans for productive AAV replication and packaging. Thus, AAV helper functions include AAV open reading frames (ORFs), including rep and cap and others such as AAP for certain AAV serotypes. The rep gene expression products have been shown to possess many functions, including, among others: recognition, binding and nicking of the AAV origin of DNA replication; DNA helicase activity; and modulation of transcription from AAV (or other heterologous) promoters. The cap gene expression products (capsid proteins) supply necessary packaging functions. AAV helper functions are used to complement AAV functions in trans that are missing from AAV vector genomes.

The term “comprising” also encompasses the term “consisting of”.

The terms “empty capsid” and “empty particle”, refer to an AAV particle that has an AAV protein shell but that lacks in whole or part a nucleic acid that encodes a protein or is transcribed into a transcript of interest flanked by AAV ITRs, i.e. a vector. Thus, an empty capsid is an AAV particle without encapsidated nucleic acid (payload). Accordingly, the empty capsid does not function to transfer a nucleic acid that encodes a protein or is transcribed into a transcript of interest into the host cell.

The term “mammalian cell comprising an exogenous nucleotide sequence” encompasses cells into which one or more exogenous nucleic acid(s) have been introduced, including the progeny of such cells. These can be the starting point for further genetic modification. Thus, the term “a mammalian cell comprising an exogenous nucleotide sequence” encompasses a cell comprising an exogenous nucleotide sequence integrated at a single site within a locus of the genome of said mammalian cell, wherein the exogenous nucleotide sequence comprises at least a first and a second recombination recognition site (these recombination recognition sites are different) flanking at least one first selection marker. In certain embodiments, the mammalian cell comprising an exogenous nucleotide sequence is a cell comprising an exogenous nucleotide sequence integrated at a single site within a locus of the genome of said cell, wherein the exogenous nucleotide sequence comprises a first and a second recombination recognition sequence flanking at least one first selection marker, and a third recombination recognition sequence located between the first and the second recombination recognition sequence, and all the recombination recognition sequences are different.

A “mammalian cell comprising an exogenous nucleotide sequence” and a “recombinant cell” are both “transfected cells”. This term includes the primary transfected cell as well as progeny derived therefrom without regard to the number of passages. Progeny may, e.g., not be completely identical in nucleic acid content to a parent cell, but may contain mutations. Mutant progeny that has the same function or biological activity as in the originally transfected cell are encompassed.

The “nucleic acids encoding AAV packaging proteins” refer generally to one or more nucleic acid molecule(s) that includes nucleotide sequences providing AAV functions deleted from an AAV vector, which is (are) to be used to produce a transduction competent recombinant AAV particle. The nucleic acids encoding AAV packaging proteins are commonly used to provide expression of AAV rep and/or cap genes to complement missing AAV functions that are necessary for AAV replication; however, the nucleic acid constructs lack AAV ITRs and can neither replicate nor package themselves. Nucleic acids encoding AAV packaging proteins can be in the form of a plasmid, phage, transposon, cosmid, virus, or particle. A number of nucleic acid constructs have been described, such as the commonly used plasmids pAAV/Ad and pIM29+45, which encode both rep and cap gene expression products. See, e.g., Samulski et al. (1989) J. Virol. 63:3822-3828; and McCarty et al. (1991) J. Virol. 65:2936-2945. Different plasmids have been described which encode rep and/or cap gene expression products (e.g., U.S. Pat. No. 5,139,941 and U.S. Pat. No. 6,376,237). Any one of these nucleic acids encoding AAV packaging proteins can comprise the DNA element or nucleic acid according to the invention.

The term “nucleic acids encoding helper proteins” refers generally to one or more nucleic acid molecule(s) that include nucleotide sequences encoding proteins and/or RNA molecules that provide adenoviral helper function(s). A plasmid with nucleic acid(s) encoding helper protein(s) can be transfected into a suitable cell, wherein the plasmid is then capable of supporting AAV particle production in said cell. Any one of these nucleic acids encoding helper proteins can comprise the DNA element or nucleic acid according to the invention. Expressly excluded from the term are infectious viral particles, as they exist in nature, such as adenovirus, herpesvirus or vaccinia virus particles.

The term “packaging proteins” refers to non-AAV derived viral and/or cellular functions upon which AAV is dependent for its replication. Thus, the term captures proteins and RNAs that are required in AAV replication, including those moieties involved in activation of AAV gene transcription, stage specific AAV mRNA splicing, AAV DNA replication, synthesis of Cap expression products and AAV capsid assembly. Viral-based accessory functions can be derived from any of the known helper viruses such as adenovirus, herpesvirus (other than herpes simplex virus type-I) and vaccinia virus.

As used herein, “AAV packaging proteins” refer to AAV-derived sequences, which function in trans for productive AAV replication. Thus, AAV packaging proteins are encoded by the major AAV open reading frames (ORFs), rep and cap. The rep proteins have been shown to possess many functions, including, among others: recognition, binding and nicking of the AAV origin of DNA replication; DNA helicase activity; and modulation of transcription from AAV (or other heterologous) promoters. The cap (capsid) proteins supply necessary packaging functions. AAV packaging proteins are used herein to complement AAV functions in trans that are missing from AAV vectors.

A “plasmid” is a form of nucleic acid or polynucleotide that typically has additional elements for expression (e.g., transcription, replication, etc.) or propagation (replication) of the plasmid. A plasmid as used herein also can be used to reference such nucleic acid or polynucleotide sequences. Accordingly, in all aspects the inventive compositions and methods are applicable to nucleic acids, polynucleotides, as well as plasmids, e.g., for producing cells that produce viral (e.g., AAV) vectors, to produce viral (e.g., AAV) particles, to produce cell culture medium that comprises viral (e.g., AAV) particles, etc.

The term “recombinant cell” as used herein denotes a cell after final genetic modification, such as, e.g., a cell expressing a polypeptide of interest or producing a rAAV particle of interest and that can be used for the production of said polypeptide of interest or rAAV particle of interest at any scale. For example, “a mammalian cell comprising an exogenous nucleotide sequence” that has been subjected to recombinase mediated cassette exchange (RMCE) whereby the coding sequences for a polypeptide of interest have been introduced into the genome of the host cell is a “recombinant cell”. Although the cell is still capable of performing further RMCE reactions, it is not intended to do so.

A “recombinant AAV vector” is derived from the wild-type genome of a virus, such as AAV by using molecular biological methods to remove the wild type genome from the virus (e.g., AAV), and replacing it with a non-native nucleic acid, such as a nucleic acid transcribed into a transcript or that encodes a protein. Typically, for AAV one or both inverted terminal repeat (ITR) sequences of the wild-type AAV genome are retained in the recombinant AAV vector. A “recombinant” AAV vector is distinguished from a wild-type viral AAV genome, since all or a part of the viral genome has been replaced with a non-native (i.e., heterologous) sequence with respect to the viral genomic nucleic acid. Incorporation of a non-native sequence therefore defines the viral vector (e.g., AAV) as a “recombinant” vector, which in the case of AAV can be referred to as a “rAAV vector.”

A recombinant vector (e.g., AAV) sequence can be packaged-referred to herein as a “particle”—for subsequent infection (transduction) of a cell, ex vivo, in vitro or in vivo. Where a recombinant vector sequence is encapsulated or packaged into an AAV particle, the particle can also be referred to as a “rAAV”. Such particles include proteins that encapsulate or package the vector genome. Particular examples include viral envelope proteins, and in the case of AAV, capsid proteins, such as AAV VP1, VP2 and VP3.

As used herein, the term “serotype” is a distinction based on AAV capsid proteins being serologically distinct. Serologic distinctiveness is determined based on the lack of cross-reactivity between antibodies to one AAV as compared to another AAV. Such cross-reactivity differences are usually due to differences in capsid protein sequences/antigenic determinants (e.g., due to VP1, VP2, and/or VP3 sequence differences of AAV serotypes). Despite the possibility that AAV variants including capsid variants may not be serologically distinct from a reference AAV or other AAV serotype, they differ by at least one nucleotide or amino acid residue compared to the reference or other AAV serotype.

Under the traditional definition, a serotype means that the virus of interest has been tested against serum specific for all existing and characterized serotypes for neutralizing activity and no antibodies have been found that neutralize the virus of interest. As more naturally occurring virus isolates are discovered and/or capsid mutants generated, there may or may not be serological differences with any of the currently existing serotypes. Thus, in cases where the new virus (e.g., AAV) has no serological difference, this new virus (e.g., AAV) would be a subgroup or variant of the corresponding serotype. In many cases, serology testing for neutralizing activity has yet to be performed on mutant viruses with capsid sequence modifications to determine if they are of another serotype according to the traditional definition of serotype. Accordingly, for the sake of convenience and to avoid repetition, the term “serotype” broadly refers to both serologically distinct viruses (e.g., AAV) as well as viruses (e.g., AAV) that are not serologically distinct that may be within a subgroup or a variant of a given serotype.

The term “transgene” is used herein to conveniently refer to a nucleic acid that is intended or has been introduced into a cell or organism. Transgenes include any nucleic acid, such as a gene that is transcribed into a transcript or that encodes a polypeptide or protein.

A “vector” refers to the portion of the recombinant plasmid sequence ultimately packaged or encapsulated, either directly or in form of a single strand or RNA, to form a viral (e.g., AAV) particle. In cases recombinant plasmids are used to construct or manufacture recombinant viral particles, the viral particle does not include the portion of the “plasmid” that does not correspond to the vector sequence of the recombinant plasmid. This non-vector portion of the recombinant plasmid is referred to as the “plasmid backbone”, which is important for cloning and amplification of the plasmid, a process that is needed for propagation and recombinant virus production, but is not itself packaged or encapsulated into virus (e.g., AAV) particles. Thus, a “vector” refers to the nucleic acid that is packaged or encapsulated by a virus particle (e.g., AAV).

### Recombinant Cell

Generally, for efficient as well as large-scale production of a proteinaceous compound of interest, such as e.g. a rAAV particle or a therapeutic polypeptide, a cell expressing and, if possible, also secreting said proteinaceous compound is required. Such a cell is termed “recombinant cell” or “recombinant production cell”.

For the generation of a “recombinant production cell” a suitable mammalian cell is transfected with the required nucleic acid sequences encoding said proteinaceous compound of interest. Transfection of additional helper polypeptides may be necessary.

For the generation of stable recombinant production cells, a second step follows, wherein a single cell stably expressing the proteinaceous compound of interest is selected. This can be done, e.g., based on the co-expression of a selection marker, which had been co-transfected with the nucleic acid sequences encoding the proteinaceous compound of interest, or be the expression of the proteinaceous compound itself.

For expression of a coding sequence, i.e. of an open reading frame, additional regulatory elements, such as a promoter and polyadenylation signal (sequence), are necessary. Thus, an open reading frame is operably linked to said additional regulatory elements for transcription. This can be achieved by integrating it into a so-called expression cassette. The minimal regulatory elements required for an expression cassette to be functional in a mammalian cell are a promoter functional in said mammalian cell, which is located upstream, i.e. 5′, to the open reading frame, and a polyadenylation signal (sequence) functional in said mammalian cell, which is located downstream, i.e. 3′, to the open reading frame. Additionally a terminator sequence may be present 3′ to the polyadenylation signal (sequence). For expression, the promoter, the open reading frame/coding region and the polyadenylation signal sequence have to be arranged in an operably linked form.

Likewise, a nucleic acid that is transcribed into a non-protein coding RNA is called “RNA gene”. Also for expression of an RNA gene, additional regulatory elements, such as a promoter and a transcription termination signal or polyadenylation signal (sequence), are necessary. The nature and localization of such elements depends on the RNA polymerase that is intended to drive the expression of the RNA gene. Thus, an RNA gene is normally also integrated into an expression cassette.

In case the proteinaceous compound of interest is an AAV particle, which is composed of different (monomeric) capsid polypeptides and a single stranded DNA molecule and which in addition requires other adenoviral helper functions for production and encapsulation, a multitude of expression cassettes differing in the contained open reading frames/coding sequences are required. In this case, at least an expression cassette for each of the transgene, the different polypeptides forming the capsid of the AAV vector, for the required helper functions as well as the VA RNA are required. Thus, individual expression cassettes for each of the helper E1A, E1B, E2A, E4orf6, the VA RNA, the rep and cap genes are required.

As outlined in the previous paragraphs, the more complex the proteinaceous compound of interest or the higher the number of additional required helper polypeptides and/or RNAs, respectively, the higher is the number of required different expression cassettes. Inherently with the number of expression cassettes, also the total size of the nucleic acid. However, there is a practical upper limit to the size of a nucleic acid that can be transferred, which is in the range of about 15 kbps (kilo-base-pairs). Above this limit handling and processing efficiency profoundly drops. This issue can be addressed by using two or more separate plasmids. Thereby the different expression cassettes are allocated to different plasmids, whereby each plasmid comprises only some of the expression cassettes.

For stable cell line development, random integration (RI) of the nucleic acid(s) carrying the expression cassettes for the proteinaceous compound of interest can be used. In general, by using RI the nucleic acids or fragments thereof integrate into the host cell's genome at random.

Alternatively, to RI, targeted integration (TI) can be used for CLD. In TI CLD, one or more nucleic acid(s) comprising the different expression cassettes is/are introduced at a predetermined locus in the host cell's genome.

In TI either homologous recombination or a recombinase mediated cassette exchange reaction (RMCE) can be employed for the integration of the nucleic acid(s) comprising the respective expression cassettes into the specific locus in the genome of the TI host cell.

### Adeno-Associated Virus (AAV)

For a general review of AAVs and of the adenovirus or herpes helper functions see, Berns and Bohensky, Advances in Virus Research, Academic Press., 32 (1987) 243-306. The genome of AAV is described in Srivastava et al., J. Virol., 45 (1983) 555-564. In U.S. Pat. No. 4,797,368 design considerations for constructing recombinant AAV vectors are described (see also WO 93/24641). Additional references describing AAV vectors are West et al., Virol. 160 (1987) 38-47; Kotin, Hum. Gene Ther. 5 (1994) 793-801; and Muzyczka J. Clin. Invest. 94 (1994) 1351. Construction of recombinant AAV vectors described in U.S. Pat. No. 5,173,414; Lebkowski et al., Mol. Cell. Biol. 8 (1988) 3988-3996; Tratschin et al., Mol. Cell. Biol. 5 (1985) 3251-3260; Tratschin et al., Mol. Cell. Biol., 4 (1994) 2072-2081; Hermonat and Muzyczka Proc. Natl. Acad. Sci. USA 81 (1984) 6466-6470; Samulski et al. J. Virol. 63 (1989) 3822-3828.

An adeno-associated virus (AAV) is a replication-deficient parvovirus. It can replicate only in cells, in which certain viral functions are provided by a co-infecting helper virus, such as adenoviruses, herpesviruses and, in some cases, poxviruses such as vaccinia. Nevertheless, an AAV can replicate in virtually any cell line of human, simian or rodent origin if the appropriate helper viral functions are present.

Without helper viral genes being present, an AAV establishes latency in its host cell. Its genome integrates into a specific site in chromosome 19 [(Chr) 19 (q13.4)], which is termed the adeno-associated virus integration site 1 (AAVS1). For specific serotypes, such as AAV-2 other integration sites have been found, such as, e.g., on chromosome 5 [(Chr) 5 (p13.3)], termed AAVS2, and on chromosome 3 [(Chr) 3 (p24.3)], termed AAVS3.

AAVs are categorized into different serotypes. These have been allocated based on parameters, such as hemagglutination, tumorigenicity and DNA sequence homology. Up to now, more than 10 different serotypes and more than a hundred sequences corresponding to different clades of AAV have been identified.

The capsid protein type and symmetry determines the tissue tropism of the respective AAV. For example, AAV-2, AAV-4 and AAV-5 are specific to retina, AAV-2, AAV-5, AAV-8, AAV-9 and AAVrh-10 are specific for brain, AAV-1, AAV-2, AAV-6, AAV-8 and AAV-9 are specific for cardiac tissue, AAV-1, AAV-2, AAV-5, AAV-6, AAV-7, AAV-8, AAV-9 and AAV-10 are specific for liver, AAV-1, AAV-2, AAV-5 and AAV-9 are specific for lung.

Pseudotyping denotes a process comprising the cross packaging of the AAV genome between various serotypes, i.e. the genome is packaged with differently originating capsid proteins.

The wild-type AAV genome has a size of about 4.7 kb. The AAV genome further comprises two overlapping genes named rep and cap, which comprise multiple open reading frames (see, e.g., Srivastava et al., J. Viral., 45 (1983) 555-564; Hermonat et al., J. Viral. 51 (1984) 329-339; Tratschin et al., J. Virol., 51 (1984) 611-619). The Rep protein encoding open reading frame provides for four proteins of different size, which are termed Rep78, Rep68, Rep52 and Rep40. These are involved in replication, rescue and integration of the AAV. The Cap protein encoding open reading frame provides four proteins, which are termed VP1, VP2, VP3, and AAP. VP1, VP2 and VP3 are part of the proteinaceous capsid of the AAV particles. The combined rep and cap open reading frames are flanked at their 5′- and 3′-ends by so-called inverted terminal repeats (ITRs). For replication, an AAV requires in addition to the Rep and Cap proteins the products of the genes EIA, EIB, E4orf6, E2A and VA of an adenovirus or corresponding factors of another helper virus.

In the case of an AAV of the serotype 2 (AAV-2), for example, the ITRs each have a length of 145 nucleotides and flank a coding sequence region of about 4470 nucleotides. Of the ITR's 145 nucleotides 125 nucleotides have a palindromic sequence and can form a T-shaped hairpin structure. This structure has the function of a primer during viral replication. The remaining 20, non-paired, nucleotides are denoted as D-sequence.

The AAV genome harbors three transcription promoters P5, P19, and P40 (Laughlin et al., Proc. Natl. Acad. Sci. USA 76 (1979) 5567-5571) for the expression of the rep and cap genes.

The ITR sequences have to be present in cis to the coding region. The ITRs provide a functional origin of replication (ori), signals required for integration into the target cell's genome, and efficient excision and rescue from host cell chromosomes or recombinant plasmids. The ITRs further comprise origin of replication like-elements, such as a Rep-protein binding site (RBS) and a terminal resolution site (TRS). It has been found that the ITRs themselves can have the function of a transcription promoter in an AAV vector (Flotte et al., J. Biol. Chem. 268 (1993) 3781-3790; Flotte et al., Proc. Natl. Acad. Sci. USA 93 (1993) 10163-10167).

For replication and encapsidation, respectively, of the viral single-stranded DNA genome an in trans organization of the rep and cap gene products are required.

The rep gene locus comprises two internal promoters, termed P5 and P19. It comprises open reading frames for four proteins. Promoter P5 is operably linked to a nucleic acid sequence providing for non-spliced 4.2 kb mRNA encoding the Rep protein Rep78 (chromatin nickase to arrest cell cycle), and a spliced 3.9 kb mRNA encoding the Rep protein Rep68 (site-specific endonuclease). Promoter P19 is operably linked to a nucleic acid sequence providing for a non-spliced mRNA encoding the Rep protein Rep52 and a spliced 3.3 kb mRNA encoding the Rep protein Rep40 (DNA helicases for accumulation and packaging).

The two larger Rep proteins, Rep78 and Rep68, are essential for AAV duplex DNA replication, whereas the smaller Rep proteins, Rep52 and Rep40, seem to be essential for progeny, single-strand DNA accumulation (Chejanovsky & Carter, Virology 173 (1989) 120-128).

The larger Rep proteins, Rep68 and Rep78, can specifically bind to the hairpin conformation of the AAV ITR. They exhibit defined enzyme activities, which are required for resolving replication at the AAV termini. Expression of Rep78 or Rep68 could be sufficient for infectious particle formation (Holscher, C., et al. J. Virol. 68 (1994) 7169-7177 and 69 (1995) 6880-6885).

It is deemed that all Rep proteins, primarily Rep78 and Rep68, exhibit regulatory activities, such as induction and suppression of AAV genes as well as inhibitory effects on cell growth (Tratschin et al., Mol. Cell. Biol. 6 (1986) 2884-2894; Labow et al., Mol. Cell. Biol., 7 (1987) 1320-1325; Khleif et al., Virology, 181 (1991) 738-741).

Recombinant overexpression of Rep78 results in phenotype with reduced cell growth due to the induction of DNA damage. Thereby the host cell is arrested in the S phase, whereby latent infection by the virus is facilitated (Berthet, C., et al., Proc. Natl. Acad. Sci. USA 102 (2005) 13634-13639).

Tratschin et al. reported that the P5 promoter is negatively auto-regulated by Rep78 or Rep68 (Tratschin et al., Mol. Cell. Biol. 6 (1986) 2884-2894). Due to the toxic effects of expression of the Rep protein, only very low expression has been reported for certain cell lines after stable integration of AAV (see, e.g., Mendelson et al., Virol. 166 (1988) 154-165).

The cap gene locus comprises one promoter, termed P40. Promoter P40 is operably linked to a nucleic acid sequence providing for 2.6 kb mRNA, which, by alternative splicing and use of alternative start codons, encodes the Cap proteins VP1 (87 kDa, non-spliced mRNA transcript), VP2 (72 kDa, from the spliced mRNA transcript), and VP3 (61 kDa, from alternative start codon). VP1 to VP3 constitute the building blocks of the viral capsid. The capsid has the function to bind to a cell surface receptor and allow for intracellular trafficking of the virus. VP3 accounts for about 90% of total viral particle protein. Nevertheless, all three proteins are essential for effective capsid production.

It has been reported that inactivation of all three capsid proteins VP1 to VP3 prevents accumulation of single-strand progeny AAV DNA. Mutations in the VP1 amino-terminus (“Lip-negative” or “Inf-negative”) still allows for assembly of single-stranded DNA into viral particles whereby the infectious titer is greatly reduced.

The AAP open reading frame is encoding the assembly activating protein (AAP). It has a size of about 22 kDa and transports the native VP proteins into the nucleolar region for capsid assembly. This open reading frame is located upstream of the VP3 protein encoding sequence.

In individual AAV particles, only one single-stranded DNA molecule is contained. This may be either the “plus” or “minus” strand. AAV viral particles containing a DNA molecule are infectious. Inside the infected cell, the parental infecting single strand is converted into a double strand, which is subsequently amplified. The amplification results in a large pool of double stranded DNA molecules from which single strands are displaced and packaged into capsids.

Adeno-associated viral (AAV) vectors can transduce dividing cells as well as resting cells. It can be assumed that a transgene introduced using an AAV vector into a target cell will be expressed for a long period. One drawback of using an AAV vector is the limitation of the size of the transgene that can be introduced into cells.

Viral vectors such as parvo-virus particles, including AAV serotypes and variants thereof, provide a means for delivery of nucleic acid into cells ex vivo, in vitro and in vivo, which encode proteins such that the cells express the encoded protein. AAVs are viruses useful as gene therapy vectors as they can penetrate cells and introduce nucleic acid/genetic material so that the nucleic acid/genetic material may be stably maintained in cells. In addition, these viruses can introduce nucleic acid/genetic material into specific sites, for example. Because AAV are not associated with pathogenic disease in humans, AAV vectors are able to deliver heterologous polynucleotide sequences (e.g., therapeutic proteins and agents) to human patients without causing substantial AAV pathogenesis or disease.

Viral vectors, which may be used, include, but are not limited to, adeno-associated virus (AAV) particles of multiple serotypes (e.g., AAV-1 to AAV-12, and others) and hybrid/chimeric AAV particles.

AAV particles may be used to advantage as vehicles for effective gene delivery. Such particles possess a number of desirable features for such applications, including tropism for dividing and non-dividing cells. Early clinical experience with these vectors also demonstrated no sustained toxicity and immune responses were minimal or undetectable. AAV are known to infect a wide variety of cell types in vivo and in vitro by receptor-mediated endocytosis or by transcytosis. These vector systems have been tested in humans targeting retinal epithelium, liver, skeletal muscle, airways, brain, joints and hematopoietic stem cells.

Recombinant AAV particles do not typically include viral genes associated with pathogenesis. Such vectors typically have one or more of the wild-type AAV genes deleted in whole or in part, for example, rep and/or cap genes, but retain at least one functional flanking ITR sequence, as necessary for the rescue, replication, and packaging of the recombinant vector into an AAV particle. For example, only the essential parts of the vector e.g., the ITR and LTR elements, respectively, are included. An AAV vector genome would therefore include sequences required in cis for replication and packaging (e.g., functional ITR sequences).

Recombinant AAV vectors, as well as methods and uses thereof, include any viral strain or serotype. As a non-limiting example, a recombinant AAV vector can be based upon any AAV genome, such as AAV-1, -2, -3, -4, -5, -6, -7, -8, -9, -10, -11, -12, 218, AAV rh74 or AAV 7m8 for example. Such vectors can be based on the same strain or serotype (or subgroup or variant), or be different from each other. As a non-limiting example, a recombinant AAV vector based upon one serotype genome can be identical to one or more of the capsid proteins that package the vector. In addition, a recombinant AAV vector genome can be based upon an AAV (e.g., AAV2) serotype genome distinct from one or more of the AAV capsid proteins that package the vector. For example, the AAV vector genome can be based upon AAV2, whereas at least one of the three capsid proteins could be an AAVI, AAV3, AAV4, AAV5, AAV6, AAV7, AAV8, AAV9, AAV10, AAV11, AAV12, AAV-218, AAV rh74, AAV 7m8 or a variant thereof, for example. AAV variants include variants and chimeras of AAV1, AAV2, AAV3, AAV4, AAV5, AAV6, AAV7, AAV8, AAV9, AAV10, AAV11, AAV12, AAV-218, AAV rh74 and AAV 7m8 capsids.

In certain embodiments of all aspects and embodiments, adeno-associated virus (AAV) vectors or particles include AAVI, AAV2, AAV3, AAV4, AAV5, AAV6, AAV7, AAV8, AAV9, AAV10, AAV11, AAV12, AAV-218, AAV rh74 and AAV 7m8, as well as variants (e.g., capsid variants, such as amino acid insertions, additions, substitutions and deletions) thereof, for example, as set forth in WO 2013/158879, WO 2015/013313 and US 2013/0059732 (disclosing LK01, LK02, LK03, etc.).

AAV and AAV variants (e.g., capsid variants) serotypes (e.g., VP1, VP2, and/or VP3 sequences) may or may not be distinct from other AAV serotypes, including, for example, AAVI-AAV12 (e.g., distinct from VP1, VP2, and/or VP3 sequences of any of AAVI-AAV12 serotypes).

In certain embodiments of all aspects and embodiments, an AAV particle related to a reference serotype has a polynucleotide, polypeptide or subsequence thereof that includes or consists of a sequence at least 80% or more (e.g., 85%, 90%, 95%, 96%, 97%, 98%, 99%, 99.1%, 99.2%, 99.3%, 99.4%, 99.5%, etc.) identical to one or more AAVI, AAV2, AAV3, AAV4, AAV5, AAV6, AAV7, AAV8, AAV9, AAV10, AAV11, AAV12, AAV-218, AAV rh74 or AAV 7m8 (e.g., such as an ITR, or a VP1, VP2, and/or VP3 sequences).

Methods and uses of the invention include AAV sequences (polypeptides and nucleotides), and subsequences thereof that exhibit less than 100% sequence identity to a reference AAV serotype such as AAVI, AAV2, AAV3, AAV4, AAV5, AAV6, AAV7, AAV8, AAV9, AAV10, AAVII, AAV12, AAV-218, AAV rh74, or AAV 7m8, but are distinct from and not identical to known AAV genes or proteins, such as AAVI, AAV2, AAV3, AAV4, AAV5, AAV6, AAV7, AAV8, AAV9, AAV10, AAV11, AAV12, AAV-218, AAV rh74, or AAV 7m8, genes or proteins, etc. In certain embodiments of all aspects and embodiments, an AAV polypeptide or subsequence thereof includes or consists of a sequence at least 75% or more identical, e.g., 80%, 85%, 85%, 87%, 88%, 89%, 90%, 91%, 92%, 93%, 94%, 95%, 96%, 97%, 98%, 99%, 99.1%, 99.2%, 99.3%, 99.4%, 99.5%, etc., up to 100% identical to any reference AAV sequence or subsequence thereof, such as AAVI, AAV2, AAV3, AAV4, AAV5, AAV6, AAV7, AAV8, AAV9, AAV10, AAV11, AAV12, AAV-218, AAV rh74, or AAV 7m8 (e.g., VP1, VP2 and/or VP3 capsid or ITR). In certain embodiments, an AAV variant has 1, 2, 3, 4, 5, 5-10, 10-15, 15-20 or more amino acid substitutions.

Recombinant AAV particles, including AAVI, AAV2, AAV3, AAV4, AAV5, AAV6, AAV7, AAV8, AAV9, AAV10, AAV11, AAV12, AAV-218, AAV rh74 or AAV 7m8, and variant, related, hybrid and chimeric sequences, can be constructed using recombinant techniques that are known to the skilled artisan, to include one or more nucleic acid sequences (transgenes) flanked with one or more functional AAV ITR sequences.

Recombinant particles (e.g., rAAV particles) can be incorporated into pharmaceutical compositions. Such pharmaceutical compositions are useful for, among other things, administration and delivery to a subject in vivo or ex vivo. In certain embodiments, the pharmaceutical composition contains a pharmaceutically acceptable carrier or excipient. Such excipients include any pharmaceutical agent that does not itself induce an immune response harmful to the individual receiving the composition, and which may be administered without undue toxicity.

Protocols for the generation of adenoviral vectors have been described in U.S. Pat. Nos. 5,998,205; 6,228,646; 6,093,699; 6,100,242; WO 94/17810 and WO 94/23744.

### Viral Genome Quantification

In order to allow correct viral genome quantification the sample must be free of plasmid DNA as well as unpackaged vector genomes, both containing at least parts of the viral genome. Further, the packaged AAV genomes must be available from the first PCR cycle.

To remove unpackaged DNA, which might interfere in the ddPCR process, DNAseI digest is commonly used.

To make the encapsulated DNA accessible for ddPCR, capsid opening is required. This can be done either by incubation at high temperature or proteinase K digest. The requirement for proteinase K digestion at all, is heavily discussed in the art.

### Droplet Digital Polymerase Chain Reaction

Droplet digital PCR (ddPCR) allows for the absolute quantitation of viral genomes without the need for the generation of a standard curve.

In more detail, droplet digital polymerase chain reaction (ddPCR) enables absolute quantification of nucleic acids by randomly distributing a PCR reaction mixture into discrete partitions, where some have no nucleic target sequences and others have one or more template copies present (Hindson, B., et al. 2011). Due to partitioning, thousands of independent PCR reactions are performed during thermal cycling. At the endpoint, the fraction of target-positive partitions is read out and used for the calculation of initial template DNA concentration (Pinheiro, L., et al. 2011)

First, up to 20,000 droplets with a volume of about 1 nL are formed in a water-oil emulsion. Thereby the PCR reaction mix, comprising of the nucleic acid template, forward (fwd) and reverse (rev) primer, a TaqMan probe and a ddPCR supermix, which contains a Thermus aquaticus (Taq) DNA polymerase, dNTPs and PCR buffer, is partitioned (see, e.g., Hindson, B., et al. 2011; Taylor, S, et al. 2017). In each droplet, an individual PCR reaction is carried out during thermal cycling, depending on presence or absence of the DNA target.

In droplets containing template DNA, target sequences are amplified. During amplification, the 5′-to-3′ exonuclease activity of Taq polymerase hydrolyses the TaqMan probe, which is bound to the template strand. Due to degradation of the probe into smaller fragments, the 5′-located fluorophore is no longer in close proximity to its 3′-located quencher. Thereby signal quenching is abolished and a fluorescence signal is generated. Partitions lacking template sequences show no amplification and therefore no hydrolysis of TaqMan probes and fluorescence generation, respectively, as the fluorescence of the 5′-located fluorophore remains quenched (see, e.g., Holland, P., et al. 1991). Since probes with distinct fluorophores are available, which have different excitation and emission wavelengths, ddPCR reactions can be performed as multiplex reactions within one droplet. Commonly used fluorophores for two-dimensional ddPCR are 6-carboxyfluorescein (FAM) and hexachloro-6-carboxyfluorescein (HEX), both quenched by black hole quencher 1 (BHQ1) (see, e.g., Furuta-Hanawa, B., et al. 2019).

As an endpoint analysis, the fluorescence signal of each droplet after thermal cycling is read out. Using Poisson statistics, the copy number of target sequences (2) can be calculated from the ratio of positive to total readouts (p), according to equation 1 (see, e.g., Hindson, B., et al. 2011).

$$λ = - ln ( 1 - p ) \qquad ( 1 )$$

Because ddPCR relies on an endpoint measurement, target sequence quantification is to a certain extent independent of the PCR reaction efficiency. This is in contrast to real time PCR (qPCR), which is commonly used for viral genome titration (see, e.g., Taylor, S, et al. 2017). Further, no standards or calibration samples need to be used (see, e.g., Dorange, F., Bec, C. 2018).

### Recombinant AAV Particles

Different methods that are known in the art for generating rAAV particles. For example, transfection using AAV plasmid and AAV helper sequences in conjunction with co-infection with one AAV helper virus (e.g., adenovirus, herpesvirus, or vaccinia virus) or transfection with a recombinant AAV plasmid, an AAV helper plasmid, and an helper function plasmid. Non-limiting methods for generating rAAV particles are described, for example, in U.S. Pat. Nos. 6,001,650, 6,004,797, WO 2017/096039, and WO 2018/226887. Following recombinant rAAV particle production (i.e. particle generation in cell culture systems), rAAV particles can be obtained from the host cells and cell culture supernatant and purified.

For the generation of recombinant AAV particles, expression of the Rep and Cap proteins, the helper proteins ELA, EIB, E2A and E4orf6 as well as the adenoviral VA RNA in a single mammalian cell is required. The helper proteins EIA, E1B, E2A and E4orf6 can be expressed using any promoter as shown by Matsushita et al. (Gene Ther. 5 (1998) 938-945), especially the CMV IE promoter. Thus, any promoter can be used.

Generally, to produce recombinant AAV particles, different, complementing plasmids are co-transfected into a host cell. One of the plasmids comprises the transgene sandwiched between the two cis acting AAV ITRs. The missing AAV elements required for replication and subsequent packaging of progeny recombinant genomes, i.e. the open reading frames for the Rep and Cap proteins, are contained in trans on a second plasmid. The overexpression of the Rep proteins results in inhibitory effects on cell growth (Li, J., et al., J. Virol. 71 (1997) 5236-5243). Additionally, a third plasmid comprising the genes of a helper virus, i.e. E1, E4orf6, E2A and VA from adenovirus, is required for AAV replication.

To reduce the number of required plasmids, Rep, Cap and the adenovirus helper genes may be combined on a single plasmid.

Alternatively, the host cell may already stably express the E1 gene products. Such a cell is a HEK293 cell. The human embryonic kidney clone denoted as 293 was generated back in 1977 by integrating adenoviral DNA into human embryonic kidney cells (HEK cells) (Graham, F. L., et al., J. Gen. Virol. 36 (1977) 59-74). The HEK293 cell line comprises base pair 1 to 4344 of the adenovirus serotype 5 genome. This encompasses the ElA and ElB genes as well as the adenoviral packaging signals (Louis, N., et al., Virology 233 (1997) 423-429).

When using HEK293 cells the missing E2A, E4orf6 and VA genes can be introduced either by co-infection with an adenovirus or by co-transfection with an E2A-, E4orf6- and VA-expressing plasmid (see, e.g., Samulski, R. J., et al., J. Virol. 63 (1989) 3822-3828; Allen, J. M., et al., J. Virol. 71 (1997) 6816-6822; Tamayose, K., et al., Hum. Gene Ther. 7 (1996) 507-513; Flotte, T. R., et al., Gene Ther. 2 (1995) 29-37; Conway, J. E., et al., J. Virol. 71 (1997) 8780-8789; Chiorini, J. A., et al., Hum. Gene Ther. 6 (1995) 1531-1541; Ferrari, F. K., et al., J. Virol. 70 (1996) 3227-3234; Salvetti, A., et al., Hum. Gene Ther. 9 (1998) 695-706; Xiao, X., et al., J. Virol. 72 (1998) 2224-2232; Grimm, D., et al., Hum. Gene Ther. 9 (1998) 2745-2760; Zhang, X., et al., Hum. Gene Ther. 10 (1999) 2527-2537). Alternatively, adenovirus/AAV or herpes simplex virus/AAV hybrid vectors can be used (see, e.g., Conway, J. E., et al., J. Virol. 71 (1997) 8780-8789; Johnston, K. M., et al., Hum. Gene Ther. 8 (1997) 359-370; Thrasher, A. J., et al., Gene Ther. 2 (1995) 481-485; Fisher, J. K., et al., Hum. Gene Ther. 7 (1996) 2079-2087; Johnston, K. M., et al., Hum. Gene Ther. 8 (1997) 359-370).

Thus, cell lines in which the rep gene is integrated and expressed tend to grow slowly or express Rep proteins at very low levels.

In order to limit the transgene activity to specific tissues, i.e. to limit the site of integration the transgene can be operably linked to an inducible or tissue specific promoter (see, e.g., Yang, Y., et al. Hum. Gene. Ther. 6 (1995) 1203-1213).

One difficulty in the production of rAAV particles is the inefficient packaging of the rAAV vector, resulting in low titers. Packaging has been difficult for several reasons including
preferred encapsidation of wild-type AAV genomes if they are present;
difficulty in generating sufficient complementing functions such as those provided by the wild-type rep and cap genes due to the inhibitory effect associated with the rep gene products;
the limited efficiency of the co-transfection of the plasmid constructs.

All this is based on the biological properties of the Rep proteins. Especially the inhibitory (cytostatic and cytotoxic) properties of the Rep proteins as well as the ability to reverse the immortalized phenotype of cultured cells is problematic. Additionally, Rep proteins down-regulate their own expression when the widely used AAV P5 promoter is employed (see, e.g., Tratschin et al., Mol. Cell. Biol. 6 (1986) 2884-2894).

In certain embodiments of all aspects and embodiments, the rAAV particles are derived from an AAV selected from the group consisting of AAVI, AAV2, AAV3, AAV4, AAV5, AAV6, AAV7, AAV8, AAV9, AAV10, Rh10, Rh74 and 7m8.

In certain embodiments of all aspects and embodiments, the rAAV particles comprise a capsid sequence having 70% or more sequence identity to an AAVI, AAV2, AAV3, AAV4, AAV5, AAV6, AAV7, AAV8, AAV9, AAV10, Rh10, Rh74, or 7m8 capsid sequence.

In certain embodiments of all aspects and embodiments, the rAAV particles comprise an ITR sequence having 70% or more sequence identity to an AAVI, AAV2, AAV3, AAV4, AAV5, AAV6, AAV7, AAV8, AAV9, or AAV10 ITR sequence.

### E1A, E1B, E2 and E4

The coding sequences of E1A and E1B (open reading frames) can be derived from a human adenovirus, such as, e.g., in particular of human adenovirus serotype 2 or serotype 5. An exemplary sequence of human Ad5 (adenovirus serotype 5) is found in GenBank entries X02996, AC_000008 and that of an exemplary human Ad2 in GenBank entry AC_000007. Nucleotides 505 to 3522 comprise the nucleic acid sequences encoding E1A and EB of human adenovirus serotype 5. Plasmid pSTK146 as reported in EP 1 230 354, as well as plasmids pGS119 and pGS122 as reported in WO 2007/056994, can also be used a source for the E1A and EIB open reading frames.

E1A is the first viral helper gene that is expressed after adenoviral DNA enters the cell nucleus. The ELA gene encodes the 12S and 13S proteins, which are based on the same E1A mRNA by alternative splicing. Expression of the 12S and 13S proteins results in the activation of the other viral functions E1B, E2, E3 and E4. Additionally, expression of the 12S and 13S proteins force the cell into the S phase of the cell cycle. If only the E1A-derived proteins are expressed, the cell will dye (apoptosis).

E1B is the second viral helper gene that is expressed. It is activated by the E1A-derived proteins 12S and 13S. The EB gene derived mRNA can be spliced in two different ways resulting in a first 55 kDa transcript and a second 19 kDa transcript. The E1B 55 kDa protein is involved in the modulation of the cell cycle, the prevention of the transport of cellular mRNA in the late phase of the infection, and the prevention of E1A-induced apoptosis. The E1B 19 kDa protein is involved in the prevention of E1A-induced apoptosis of cells.

The E2 gene encodes different proteins. The E2A transcript codes for the single strand-binding protein (SSBP), which is essential for AAV replication

In addition, the E4 gene encodes several proteins. The E4 gene derived 34 kDa protein (E4orf6) prevents the accumulation of cellular mRNAs in the cytoplasm together with the E1B 55 kDa protein, but also promotes the transport of viral RNAs from the cell nucleus into the cytoplasm.

### Adenoviral VA RNA Gen

The viral associated RNA (VA RNA) is a non-coding RNA of adenovirus (Ad), regulating translation. The adenoviral genome comprises two independent copies: VAI (VA RNAI) and VAII (VA RNAII). Both are transcribed by RNA polymerase III (see, e.g., Machitani, M., et al., J. Contr. Rel. 154 (2011) 285-289) from a type 2 polymerases III promoter. For recombinant production, the adenoviral VA RNA gene can be driven by any promoter.

The structure, function, and evolution of adenovirus-associated RNA using a phylogenetic approach was investigated by Ma, Y. and Mathews, M. B. (J. Virol. 70 (1996) 5083-5099). They provided alignments as well as consensus VA RNA sequences based on 47 known human adenovirus serotypes.

VA RNAs, VAI and VAII, are consisting of 157-160 nucleotides (nt).

Depending on the serotype, adenoviruses contain one or two VA RNA genes. VA RNAI is believed to play the dominant pro-viral role, while VA RNAII can partially compensate for the absence of VA RNAI (Vachon, V. K. and Conn, G. L., Virus Res. 212 (2016) 39-52).

The VA RNAs are not essential, but play an important role in efficient viral growth by overcoming cellular antiviral machinery. That is, although VA RNAs are not essential for viral growth, VA RNA-deleted adenovirus cannot grow during the initial step of vector generation, where only a few copies of the viral genome are present per cell, possibly because viral genes other than VA RNAs that block the cellular antiviral machinery may not be sufficiently expressed (see Maekawa, A., et al. Nature Sci. Rep. 3 (2013) 1136).

Maekawa, A., et al. (Nature Sci. Rep. 3 (2013) 1136) reported efficient production of adenovirus vector lacking genes of virus-associated RNAs that disturb cellular RNAi machinery, wherein HEK293 cells that constitutively and highly express flippase recombinase were infected to obtain VA RNA-deleted adenovirus by FLP recombinase-mediated excision of the VA RNA locus.

The human adenovirus 2 VA RNAI corresponds to nucleotides 10586-10810 of GenBank entry AC_000007 sequence. The human adenovirus 5 VA RNAI corresponds to nucleotides 10579-10820 of GenBank entry AC_000008 sequence.

### Methods for Producing Raav Particles

Carter et al. have shown that the entire rep and cap open reading frames in the wild-type AAV genome can be deleted and replaced with a transgene (Carter, B. J., in “Handbook of Parvoviruses”, ed. by P. Tijssen, CRC Press, pp. 155-168 (1990)). Further, it has been reported that the ITRs have to be maintained to retain the function of replication, rescue, packaging, and integration of the transgene into the genome of the target cell.

When cells comprising the respective viral helper genes are transduced by an AAV vector, or, vice versa, when cells comprising an integrated AAV provirus are transduced by a suitable helper virus, then the AAV provirus is activated and enters a lytic infection cycle again (Clark, K. R., et al., Hum. Gene Ther. 6 (1995) 1329-1341; Samulski, R. J., Curr. Opin. Genet. Dev. 3 (1993) 74-80).

Aspects of the current invention are methods of transducing cells with nucleic acids (e.g., plasmids) comprising all required elements for the production of recombinant AAV particles, wherein the method according to the current invention is used for full AAV particle determination. Thus, as the plasmids encode viral packaging proteins and/or helper proteins the cells can produce recombinant viral particles that include a nucleic acid that encodes a protein of interest or comprises a sequence that is transcribed into a transcript of interest.

The invention provides a viral (e.g., AAV) particle production platform that includes features that distinguish it from current ‘industry-standard’ viral (e.g., AAV) particle production processes by using the method according to the current invention.

More generally, cells transfected or transduced with DNA for the recombinant production of AAV particles can be referred to as “recombinant cell”. Such a cell can be, for example, a yeast cell, an insect cell, or a mammalian cell, and has been used as recipient of a nucleic acid (plasmid) encoding packaging proteins, such as AAV packaging proteins, a nucleic acid (plasmid) encoding helper proteins, and a nucleic acid (plasmid) that encodes a protein or is transcribed into a transcript of interest, i.e. a transgene placed between two AAV ITRs. The term includes the progeny of the original cell, which has been transduced or transfected. It is understood that the progeny of a single parental cell may not necessarily be completely identical in morphology or in genomic or total nucleic acid complement as the original parent, due to natural, accidental, or deliberate mutation.

Numerous cell growth media appropriate for sustaining cell viability or providing cell growth and/or proliferation are commercially available. Examples of such medium include serum free eukaryotic growth mediums, such as medium for sustaining viability or providing for the growth of mammalian (e.g., human) cells. Non-limiting examples include Ham's F12 or F12K medium (Sigma-Aldrich), FreeStyle (FS) F17 medium (Thermo-Fisher Scientific), MEM, DMEM, RPMI-1640 (Thermo-Fisher Scientific) and mixtures thereof. Such media can be supplemented with vitamins and/or trace minerals and/or salts and/or amino acids, such as essential amino acids for mammalian (e.g., human) cells.

Helper protein plasmids can be in the form of a plasmid, phage, transposon or cosmid. In particular, it has been demonstrated that the full-complement of adenovirus genes are not required for helper functions. For example, adenovirus mutants incapable of DNA replication and late gene synthesis have been shown to be permissive for AAV replication. Ito et al., J. Gen. Virol. 9 (1970) 243; Ishibashi et al., Virology 45 (1971) 317.

Mutants within the E2B and E3 regions have been shown to support AAV replication, indicating that the E2B and E3 regions are probably not involved in providing helper function. Carter et al., Virology 126 (1983) 505. However, adenoviruses defective in the E1 region, or having a deleted E4 region, are unable to support AAV replication. Thus, for adenoviral helper proteins, E1A and E4 regions are likely required for AAV replication, either directly or indirectly (see, e.g., Laughlin et al., J. Virol. 41 (1982) 868; Janik et al., Proc. Natl. Acad. Sci. USA 78 (1981) 1925; Carter et al., Virology 126 (1983) 505). Other characterized adenoviral mutants include: E1B (Laughlin et al. (1982), supra; Janik et al. (1981), supra; Ostrove et al., Virology 104 (1980) 502); E2A (Handa et al., J. Gen. Virol. 29 (1975) 239; Strauss et al., J. Virol. 17 (1976) 140; Myers et al., J. Virol. 35 (1980) 665; Jay et al., Proc. Natl. Acad. Sci. USA 78 (1981) 2927; Myers et al., J. Biol. Chem. 256 (1981) 567); E2B (Carter, Adeno-Associated Virus Helper Functions, in I CRC Handbook of Parvoviruses (P. Tijssen ed., 1990)); E3 (Carter et al. (1983), supra); and E4 (Carter et al. (1983), supra; Carter (1995)).

Studies of the helper proteins provided by adenoviruses having mutations in the E1B have reported that the E1B 55 kDa protein is required for AAV particle production, while E1B 19 kDa is not. In addition, WO 97/17458 and Matshushita et al. (Gene Therapy 5 (1998) 938-945) described helper function plasmids encoding various adenoviral genes. An example of a helper plasmid comprise an adenovirus VA RNA coding region, an adenovirus E4orf6 coding region, an adenovirus E2A 72 kDa coding region, an adenovirus E1A coding region, and an adenovirus E1B region lacking an intact E1B 55 kDa coding region (see, e.g., WO 01/83797).

Thus, herein is provided a method for producing recombinant AAV vectors or AAV particles comprising said recombinant AAV vectors, which comprise a nucleic acid that encodes a protein or is transcribed into a transcript of interest, using the method according to the current invention for full capsid determination.

One aspect of the current invention is a method for producing recombinant AAV vectors or AAV particles comprising said recombinant AAV vectors, which comprise a nucleic acid that encodes a protein or is transcribed into a transcript of interest, comprises the steps of
(i) providing one or more plasmids comprising nucleic acids encoding AAV packaging proteins and/or nucleic acids encoding helper proteins;
(ii) providing a plasmid comprising a nucleic acid that encodes a protein of interest or is transcribed into a transcript of interest;
(iii) contacting one or more mammalian or insect cells with the provided plasmids;
(iv) either further adding a transfection reagent and optionally incubating the plasmid/transfection reagent/cell mixture; or providing a physical means, such as an electric current, to introduce the nucleic acid into the cells;
(v) cultivating the transfected cells;
(vi) harvesting the cultivated cells and/or culture medium from the cultivated cells to produce a cell and/or culture medium harvest; and
(vii) lysing the cells and optionally isolating recombinant AAV vector or AAV particle from the cell and/or culture medium harvest lysate;
(viii) determining the full AAV particle fraction in or after steps (vi) or/and step (vii) with a method according to the current invention;
thereby producing a recombinant AAV vector or AAV particle comprising a nucleic acid that encodes a protein of interest or is transcribed into a transcript of interest.

One aspect of the current invention is a method for producing recombinant AAV vectors or AAV particles comprising said recombinant AAV vectors, which comprise a nucleic acid that encodes a protein or is transcribed into a transcript of interest, comprises the steps of
(i) providing one or more plasmids comprising nucleic acids encoding AAV packaging proteins and/or nucleic acids encoding helper proteins;
(ii) providing a plasmid comprising a nucleic acid that encodes a protein of interest or is transcribed into a transcript of interest;
(iii)
   (a) either generating a stable transfected cell by
      contacting one or more mammalian or insect cells with the provided plasmids of (i);
      either further adding a transfection reagent and optionally incubating the plasmid/transfection reagent/cell mixture; or providing a physical means, such as an electric current, to introduce the nucleic acid into the cells;
      selecting a first stably transfected cell;
      contacting the selected first stably transfected cell with the provided plasmid of (ii); and
      either further adding a transfection reagent and optionally incubating the plasmid/transfection reagent/cell mixture; or providing a physical means, such as an electric current, to introduce the nucleic acid into the cells;
   or
   (b) generating a transient transfected cell by
      contacting one or more mammalian or insect cells with the provided plasmids of (i) and (ii); and
      either further adding a transfection reagent and optionally incubating the plasmid/transfection reagent/cell mixture; or providing a physical means, such as an electric current, to introduce the nucleic acid into the cells;
(iv) cultivating the transfected cell of (iii);
(v) harvesting the cultivated cells and/or culture medium from the cultivated cells to produce a cell and/or culture medium harvest;
(vi) lysing the cells and optionally isolating recombinant AAV vector or AAV particle from the cell and/or culture medium harvest lysate;
(vii) determining full capsids in or after step (v) or/and step (vi) with the method according to the current invention;
thereby producing recombinant AAV vector or AAV particle comprising a nucleic acid that encodes a protein of interest or is transcribed into a transcript of interest.

One aspect of the current invention is a method for producing recombinant AAV vectors or AAV particles comprising said recombinant AAV vectors, which comprise a nucleic acid that encodes a protein or is transcribed into a transcript of interest, comprises the steps of
(i) providing a mammalian or insect cell comprising nucleic acids encoding AAV packaging proteins and/or nucleic acids encoding helper proteins;
(ii) providing a plasmid comprising a nucleic acid that encodes a protein of interest or is transcribed into a transcript of interest;
(iii)
   (a) either generating a stable transfected cell by
      contacting one or more mammalian or insect cells with the provided plasmids of (i);
      either further adding a transfection reagent and optionally incubating the plasmid/transfection reagent/cell mixture; or providing a physical means, such as an electric current, to introduce the nucleic acid into the cells;
      selecting a first stably transfected cell;
      contacting the selected first stably transfected cell with the provided plasmid of (ii); and
      either further adding a transfection reagent and optionally incubating the plasmid/transfection reagent/cell mixture; or providing a physical means, such as an electric current, to introduce the nucleic acid into the cells;
   or
   (b) generating a transient transfected cell by
      contacting one or more mammalian or insect cells with the provided plasmids of (i) and (ii); and
      either further adding a transfection reagent and optionally incubating the plasmid/transfection reagent/cell mixture; or providing a physical means, such as an electric current, to introduce the nucleic acid into the cells;
(iv) cultivating the transfected cell of (iii);
(v) harvesting the cultivated cells and/or culture medium from the cultivated cells to produce a cell and/or culture medium harvest;
(vi) lysing the cells and optionally isolating and/or purifying recombinant AAV vector or AAV particle from the cell and/or culture medium harvest; and
(vii) determining full AAV particles in or after step (v) or/and step (vi) with the method according to the current invention;
thereby producing recombinant AAV vector or AAV particle comprising a nucleic acid that encodes a protein of interest or is transcribed into a transcript of interest.

The introduction of the nucleic acid (plasmids) into cells can be done in multiple ways.

Diverse methods for the DNA transfer into mammalian cells have been reported in the art. These are all useful in the methods according to the current invention. In certain embodiments of all aspects and embodiments, electroporation, nucleofection, or microinjection for nucleic acid transfer/transfection is used. In certain embodiments of all aspects and embodiments, an inorganic substance (such as, e.g., calcium phosphate/DNA co-precipitation), a cationic polymer (such as, e.g., polyethylenimine, DEAE-dextran), or a cationic lipid (lipofection) is used for nucleic acid transfer/transfection is used. Calcium phosphate and polyethylenimine are the most commonly used reagents for transfection for nucleic acid transfer in larger scales (see, e.g., Baldi et al., Biotechnol. Lett. 29 (2007) 677-684), whereof polyethylenimine is preferred.

In certain embodiments of all aspects and embodiments, the nucleic acid (plasmid) is provided in a composition in combination with polyethylenimine (PEI), optionally in combination with cells. In certain embodiments, the composition includes a plasmid/PEI mixture, which has a plurality of components: (a) one or more plasmids comprising nucleic acids encoding AAV packaging proteins and/or nucleic acids encoding helper proteins; (b) a plasmid comprising a nucleic acid that encodes a protein or is transcribed into a transcript of interest; and (c) a polyethylenimine (PEI) solution. In certain embodiments, the plasmids are in a molar ratio range of about 1:0.01 to about 1:100, or are in a molar ratio range of about 100:1 to about 1:0.01, and the mixture of components (a), (b) and (c) has optionally been incubated for a period of time from about 10 seconds to about 4 hours.

In certain embodiments of all aspects and embodiments, the compositions further comprise cells. In certain embodiments, the cells are in contact with the plasmid/PEI mixture of components (a), (b) and/or (c).

In certain embodiments of all aspects and embodiments, the composition, optionally in combination with cells, further comprise free PEI. In certain embodiments, the cells are in contact with the free PEI.

In certain embodiments of all aspects and embodiments, the cells have been in contact with the mixture of components (a), (b) and/or (c) for at least about 4 hours, or about 4 hours to about 140 hours, or for about 4 hours to about 96 hours. In one preferred embodiment, the cells have been in contact with the mixture of components (a), (b) and/or (c) and optionally free PEI, for at least about 4 hours.

The composition may comprise further plasmids or/and cells. Such plasmids and cells may be in contact with free PEI. In certain embodiments, the plasmids and/or cells have been in contact with the free PEI for at least about 4 hours, or about 4 hours to about 140 hours, or for about 4 hours to about 96 hours.

Additionally provided are methods for producing recombinant AAV vector or AAV particle comprising a nucleic acid that encodes a protein or is transcribed into a transcript of interest, which includes providing one or more plasmids comprising nucleic acids encoding AAV packaging proteins and/or nucleic acids encoding helper proteins; providing a plasmid comprising a nucleic acid that encodes a protein of interest or is transcribed into a transcript of interest; providing a solution comprising polyethylenimine (PEI); mixing the aforementioned plasmids with the PEI solution, wherein the plasmids are in a molar ratio range of about 1:0.01 to about 1:100, or are in a molar ratio range of about 100:1 to about 1:0.01, to produce a plasmid/PEI mixture (and optionally incubating the plasmid/PEI mixture for a period of time in the range of about 10 seconds to about 4 hours); contacting cells with the plasmid/PEI mixture produced as described to produce a plasmid/PEI cell culture; adding free PEI to the plasmid/PEI cell culture produced as described to produce a free PEI/plasmid/PEI cell culture; incubating the plasmid/PEI cell culture or the free PEI/plasmid/PEI cell culture produced for at least about 4 hours to produce transfected cells; harvesting the transfected cells produced and/or culture medium from the transfected cells produced to produce a cell and/or culture medium harvest; lysing the cells and optionally isolating the recombinant AAV vector or particle from the cell and/or culture medium harvest lysate, whereby full capsids are determined in the lysate or the isolated AAV particle with a method according to the current invention; and thereby producing recombinant AAV vector or particle comprising a nucleic acid that encodes a protein or is transcribed into a transcript of interest.

Methods for producing recombinant AAV vectors or AAV particles using the method according to the current invention can include one or more further steps or features. An exemplary step or feature includes, but is not limited to, a step of harvesting the cultivated cells produced and/or harvesting the culture medium from the cultivated cells produced to produce a cell and/or culture medium harvest. An additional exemplary step or feature includes, but is not limited to lysing the harvested cells and optionally isolating the recombinant AAV vector or AAV particle from the cell and/or culture medium harvest lysate; whereby the viral genome copy number is determined using a method according to the current invention; and thereby producing recombinant AAV vector or AAV particle comprising a nucleic acid that encodes a protein or is transcribed into a transcript of interest.

Encoded AAV packaging proteins include, in certain embodiments of all aspects and embodiments, AAV rep and/or AAV cap. Such AAV packaging proteins include, in certain embodiments of all aspects and embodiments, AAV rep and/or AAV cap proteins of any AAV serotype.

Encoded helper proteins include, in certain embodiments of all aspects and embodiments, adenovirus E1A and E1B, adenovirus E2 and/or E4, VA RNA, and/or non-AAV helper proteins.

In certain embodiments of all aspects and embodiments, a first plasmid comprises the nucleic acids encoding AAV packaging proteins and a second plasmid comprises the nucleic acids encoding helper proteins.

In certain embodiments of all aspects and embodiments, the molar ratio of the plasmid comprising the nucleic acid that encodes a protein or is transcribed into a transcript of interest to a first plasmid comprising the nucleic acids encoding AAV packaging proteins to a second plasmid comprising the nucleic acids encoding helper proteins is in the range of about 1-5:1:1, or 1:1-5:1, or 1:1:1-5 in co-transfection.

In certain embodiments of all aspects and embodiments, the cell is a eukaryotic cell. In certain embodiments, the eukaryotic cell is a mammalian cell. In one preferred embodiment, the cell is a HEK293 cell or a CHO cell.

The cultivation can be performed using the generally used conditions for the cultivation of eukaryotic cells of about 37° C., 95% humidity and 8 vol.-% CO2. The cultivation can be performed in serum containing or serum free medium, in adherent culture or in suspension culture. The suspension cultivation can be performed in any fermentation vessel, such as, e.g., in stirred tank reactors, wave reactors, rocking bioreactors, shaker vessels or spinner vessels or so called roller bottles. Transfection can be performed in high throughput format and screening, respectively, e.g. in a 96 or 384 well format.

Methods according to the current invention include AAV particles of any serotype, or a variant thereof. In certain embodiments of all aspects and embodiments, a recombinant AAV particle comprises any of AAV serotypes 1-12, an AAV VP1, VP2 and/or VP3 capsid protein, or a modified or variant AAV VP1, VP2 and/or VP3 capsid protein, or wild-type AAV VP1, VP2 and/or VP3 capsid protein. In certain embodiments of all aspects and embodiments, an AAV particle comprises an AAV serotype or an AAV pseudotype, where the AAV pseudotype comprises an AAV capsid serotype different from an ITR serotype.

Methods according to the invention that provide or include AAV vectors or particles can also include other elements. Examples of such elements include but are not limited to: an intron, an expression control element, one or more adeno-associated virus (AAV) inverted terminal repeats (ITRs) and/or a filler/stuffer polynucleotide sequence. Such elements can be within or flank the nucleic acid that encodes a protein or is transcribed into a transcript of interest, or the expression control element can be operably linked to nucleic acid that encodes a protein or is transcribed into a transcript of interest, or the AAV ITR(s) can flank the 5′- or 3′-terminus of nucleic acid that encodes a protein or is transcribed into a transcript of interest, or the filler polynucleotide sequence can flank the 5′- or 3′-terminus of nucleic acid that encodes a protein or is transcribed into a transcript of interest.

Expression control elements include constitutive or regulatable control elements, such as a tissue-specific expression control element or promoter.

ITRs can be any of AAV2 or AAV6 or AAV8 or AAV9 serotypes, or a combination thereof. AAV particles can include any VP1, VP2 and/or VP3 capsid protein having 75% or more sequence identity to any of AAVI, AAV2, AAV3, AAV4, AAV5, AAV6, AAV10, AAV11, AAV-218, AAV rh74 or AAV 7m8 VP1, VP2 and/or VP3 capsid proteins, or comprises a modified or variant VP1, VP2 and/or VP3 capsid protein selected from any of: AAV1, AAV2, AAV3, AAV4, AAV5, AAV6, AAV10, AAV11, AAV-218, AAV rh74 and AAV 7m8 AAV serotypes.

Following production of recombinant viral (e.g., AAV) particles as set forth herein, if desired, the viral (e.g., rAAV) particles can be purified and/or isolated from host cells using a variety of conventional methods. Such methods include column chromatography, CsCl gradients, iodixanol gradient and the like.

For example, a plurality of column purification steps such as purification over an anion exchange column, an affinity column and/or a cation exchange column can be used. (See, e.g., WO 02/12455 and US 2003/0207439). Alternatively, or in addition, an iodixanol or CsCl gradient steps can be used (see, e.g., US 2012/0135515; and US 2013/0072548). Further, if the use of infectious virus is employed to express the packaging and/or helper proteins, residual virus can be inactivated, using various methods. For example, adenovirus can be inactivated by heating to temperatures of approximately 60° C. for, e.g., 20 minutes or more. This treatment effectively inactivates the helper virus since AAV is heat stable while the helper adenovirus is heat labile.

An objective in the rAAV vector production and purification systems is to implement strategies to minimize/control the generation of production related impurities such as proteins, nucleic acids, and vector-related impurities, including wild-type/pseudo wild-type AAV species (wtAAV) and AAV-encapsulated residual DNA impurities.

Considering that the rAAV particle represents only a minor fraction of the biomass, rAAV particles need to be purified to a level of purity, which can be used as a clinical human gene therapy product (see, e.g., Smith P. H., et al., Mo. Therapy 7 (2003) 8348; Chadeuf G., et al, Mo. Therapy 12 (2005) 744; report from the CHMP gene therapy expert group meeting, European Medicines Agency EMEA/CHMP 2005, 183989/2004).

As an initial step, typically the cultivated cells that produce the rAAV particles are harvested, optionally in combination with harvesting cell culture supernatant (medium) in which the cells (suspension or adherent) producing rAAV particles have been cultured. The harvested cells and optionally cell culture supernatant may be used as is, as appropriate, lysed or concentrated. Further, if infection is employed to express helper functions, residual helper virus can be inactivated. For example, adenovirus can be inactivated by heating to temperatures of approximately 60° C. for, e.g., 20 minutes or more, which inactivates only the helper virus since AAV is heat stable while the helper adenovirus is heat labile.

Cells and/or supernatant of the harvest are lysed by disrupting the cells, for example, by chemical or physical means, such as detergent, microfluidization and/or homogenization, to release the rAAV particles. Concurrently during cell lysis or subsequently after cell lysis, a nuclease, such as, e.g., benzonase, is added to degrade contaminating DNA. Typically, the resulting lysate is clarified to remove cell debris, e.g. by filtering or centrifuging, to render a clarified cell lysate. In a particular example, lysate is filtered with a micron diameter pore size filter (such as a 0.1-10.0 μm pore size filter, for example, a 0.45 μm and/or pore size 0.2 μm filter), to produce a clarified lysate.

The lysate (optionally clarified) contains AAV particles (comprising rAAV vectors with encapsidated nucleic acid as well as empty particles) and production/process related impurities, such as soluble cellular components from the host cells that can include, inter alia, cellular proteins, lipids, and/or nucleic acids, and cell culture medium components. The optionally clarified lysate is then subjected to purification steps to purify AAV particles (comprising rAAV vectors) from impurities using chromatography. The clarified lysate may be diluted or concentrated with an appropriate buffer prior to the first chromatography step.

After cell lysis, optional clarifying, and optional dilution or concentration, a plurality of subsequent and sequential chromatography steps can be used to purify rAAV particles.

A first chromatography step may be cation exchange chromatography or anion exchange chromatography. If the first chromatography step is cation exchange chromatography the second chromatography step can be anion exchange chromatography or size exclusion chromatography (SEC). Thus, in certain embodiments of all aspects and embodiments, rAAV particle purification is via cation exchange chromatography, followed by purification via anion exchange chromatography.

Alternatively, if the first chromatography step is cation exchange chromatography the second chromatography step can be size exclusion chromatography (SEC). Thus, in certain embodiments of all aspects and embodiments, rAAV particle purification is via cation exchange chromatography, followed by purification via size exclusion chromatography (SEC).

Still alternatively, a first chromatography step may be affinity chromatography. If the first chromatography step is affinity chromatography the second chromatography step can be anion exchange chromatography. Thus, in certain embodiments of all aspects and embodiments, rAAV particle purification is via affinity chromatography, followed by purification via anion exchange chromatography.

Optionally, a third chromatography can be added to the foregoing chromatography steps. Typically, the optional third chromatography step follows cation exchange, anion exchange, size exclusion or affinity chromatography.

Thus, in certain embodiments of all aspects and embodiments, rAAV particle purification is via cation exchange chromatography, followed by purification via anion exchange chromatography, followed by purification via size exclusion chromatography (SEC).

In addition, in certain embodiments of all aspects and embodiments, further rAAV particle purification is via cation exchange chromatography, followed by purification via size exclusion chromatography (SEC), followed by purification via anion exchange chromatography.

In yet further embodiments of all aspects and embodiments, rAAV particle purification is via affinity chromatography, followed by purification via anion exchange chromatography, followed by purification via size exclusion chromatography (SEC).

In yet further embodiments of all aspects and embodiments, rAAV particle purification is via affinity chromatography, followed by purification via size exclusion chromatography (SEC), followed by purification via anion exchange chromatography.

Cation exchange chromatography functions to separate the AAV particles from cellular and other components present in the clarified lysate and/or column eluate from an affinity or size exclusion chromatography. Examples of strong cation exchange resins capable of binding rAAV particles over a wide pH range include, without limitation, any sulfonic acid based resin as indicated by the presence of the sulfonate functional group, including aryl and alkyl substituted sulfonates, such as sulfopropyl or sulfoethyl resins. Representative matrices include but are not limited to POROS HS, POROS HS 50, POROS XS, POROS SP, and POROS S (strong cation exchangers available from Thermo Fisher Scientific, Inc., Waltham, MA, USA). Additional examples include Capto S, Capto S ImpAct, Capto S ImpRes (strong cation exchangers available from GE Healthcare, Marlborough, MA, USA), and commercial DOWEX®, AMBERLITER, and AMBERLYSTR families of resins available from Aldrich Chemical Company (Milliwaukee, WI, USA). Weak cation exchange resins include, without limitation, any carboxylic acid based resin. Exemplary cation exchange resins include carboxymethyl (CM), phospho (based on the phosphate functional group), methyl sulfonate(S) and sulfopropyl (SP) resins.

Anion exchange chromatography functions to separate AAV particles from proteins, cellular and other components present in the clarified lysate and/or column eluate from an affinity or cation exchange or size exclusion chromatography. Anion exchange chromatography can also be used to reduce and thereby control the amount of empty particles in the eluate. For example, the anion exchange column having rAAV particle bound thereto can be washed with a solution comprising NaCl at a modest concentration (e.g., about 100-125 mM, such as 110-115 mM) and a portion of the empty particles can be eluted in the flow through without substantial elution of the rAAV particles. Subsequently, rAAV particles bound to the anion exchange column can be eluted using a solution comprising NaCl at a higher concentration (e.g., about 130-300 mM NaCl), thereby producing a column eluate with reduced or depleted amounts of empty capsids and proportionally increased amounts of rAAV particles comprising an rAAV vector.

Exemplary anion exchange resins include, without limitation, those based on polyamine resins and other resins. Examples of strong anion exchange resins include those based generally on the quaternized nitrogen atom including, without limitation, quaternary ammonium salt resins such as trialkylbenzyl ammonium resins. Suitable exchange chromatography materials include, without limitation, MACRO PREP Q (strong anion-exchanger available from BioRad, Hercules, CA, USA); UNOSPHERE Q (strong anion-exchanger available from BioRad, Hercules, CA, USA); POROS 50HQ (strong anion-exchanger available from Applied Biosystems, Foster City, CA, USA); POROS XQ (strong anion-exchanger available from Applied Biosystems, Foster City, CA, USA); POROS SOD (weak anion-exchanger available from Applied Biosystems, Foster City, CA, USA); POROS 50PI (weak anion-exchanger available from Applied Biosystems, Foster City, CA, USA); Capto Q, Capto XQ, Capto Q ImpRes, and SOURCE 30Q (strong anion-exchanger available from GE healthcare, Marlborough, MA, USA); DEAE SEPHAROSE (weak anion-exchanger available from Amersham Biosciences, Piscataway, NJ, USA); Q SEPHAROSE (strong anion-exchanger available from Amersham Biosciences, Piscataway, NJ, USA). Additional exemplary anion exchange resins include aminoethyl (AE), diethylaminoethyl (DEAE), diethylaminopropyl (DEPE) and quaternary amino ethyl (QAE).

Exemplary processes for recombinant AAV particle purification are reported in WO 2019/006390.

The below outlined recombinant adeno-associated virus particle (rAAV particle) purification and production methods are scalable up to large scale. For example, to a suspension culture of 5, 10, 10-20, 20-50, 50-100, 100-200 or more liters volume. The recombinant adeno-associated virus particle purification and production methods are applicable to a wide variety of AAV serotypes/capsid variants.

In certain embodiments of all aspects and embodiments, the purification of rAAV particles comprises the steps of:
(a) harvesting cells and/or cell culture supernatant comprising rAAV particles to produce a harvest;
(b) optionally concentrating the harvest produced in step (a) to produce a concentrated harvest;
(c) lysing the harvest produced in step (a) or the concentrated harvest produced in step (b) to produce a lysate;
(d) treating the lysate produced in step (c) to reduce contaminating nucleic acid in the lysate thereby producing a nucleic acid reduced lysate;
(e) optionally filtering the nucleic acid reduced lysate produced in step (d) to produce a clarified lysate, and optionally diluting the clarified lysate to produce a diluted clarified lysate;
(f) subjecting the nucleic acid reduced lysate of step (d), the clarified lysate of step (e), or the diluted clarified lysate produced in step (e) to a cation exchange column chromatography to produce a column eluate comprising rAAV particles, thereby separating rAAV particles from protein impurities or other production/process related impurities, and optionally diluting the column eluate to produce a diluted column eluate;
(g) subjecting the column eluate or the diluted column eluate produced in step (f) to an anion exchange chromatography to produce a second column eluate comprising rAAV particles, thereby separating rAAV particles from protein impurities or production/process related impurities, and optionally concentrating the second column eluate to produce a concentrated second column eluate;
(h) subjecting the second column eluate or the concentrated second column eluate produced in step (g) to a size exclusion column chromatography (SEC) to produce a third column eluate comprising rAAV particles, thereby separating rAAV particles from protein impurities or production/process related impurities, and optionally concentrating the third column eluate to produce a concentrated third column eluate; and
(i) filtering the third column eluate or the concentrated third column eluate produced in step (h), thereby producing purified rAAV particles;
whereby full particles are determined with the method according to the invention in or after one or more of steps (a) to (i).

In certain embodiments of all aspects and embodiments, the AAV affinity column comprises a protein or ligand that binds to AAV capsid protein. Non-limiting examples of a protein include an antibody that binds to AAV capsid protein. More specific non-limiting examples include a single-chain Llama antibody (Camelid) that binds to AAV capsid protein.

In certain embodiments of all aspects and embodiments, the cells are suspension growing or adherent growing cells.

In certain embodiments of all aspects and embodiments, the cells are mammalian cells. Non-limiting examples include HEK cells, such as HEK-293 cells, and CHO cells, such as CHO-K1 cells.

Methods to determine infectious titer of rAAV particles containing a transgene are known in the art (see, e.g., Zhen et al., Hum. Gene Ther. 15 (2004) 709). Methods for assaying for empty particles and rAAV particles with packaged transgenes are known (see, e.g., Grimm et al., Gene Therapy 6 (1999) 1322-1330; Sommer et al., Malec. Ther. 7 (2003) 122-128).

To determine the presence or amount of degraded/denatured capsid, purified rAAV particle can be subjected to SDS-polyacrylamide gel electrophoresis, consisting of any gel capable of separating the three capsid proteins, for example, a gradient gel, then running the gel until sample is separated, and blotting the gel onto nylon or nitrocellulose membranes. Anti-AAV capsid antibodies are then used as primary antibodies that bind to denatured capsid proteins (see, e.g., Wobus et al., J. Viral. 74 (2000) 9281-9293). A secondary antibody that binds to the primary antibody contains a means for detecting the primary antibody. Binding between the primary and secondary antibodies is detected semi-quantitatively to determine the amount of capsids. Another method would be analytical HPLC with a SEC column or analytical ultracentrifuge.

### Data Dimension Reduction Techniques

Rapid spectroscopic ‘finger-printing’ techniques like Near-, Mid-Infrared, Raman, or 2D-Fluorescence spectroscopies, are relatively inexpensive and are well suited to analyze complex mixtures. These methods generate very large amounts of high dimensional data that can only be handled by chemometric methods like principal component analysis (PCA) or partial least squares (PLS) modeling. The combination of complex spectroscopic methods and chemometrics is commonly used in identity testing for raw materials or as a tool for the classification of raw materials.

For classification approaches, such as differentiation of “full” and “empty” capsids in the method according to the current invention, any suitable statistical and machine learning/deep learning techniques can be applied. Without limitation, further following, but not limited to these, alternative methods can be used for classification:
Principal component analysis (PCA)
Non-negative matrix factorization (NMF)
Linear Discriminant Analysis (LDA)
Generalized discriminant analysis (GDA)
canonical correlation analysis (CCA)
Autoencoder
T-distributed Stochastic Neighbor Embedding (t-SNE)
Uniform manifold approximation and projection (UMAP)
K-nearest neighbors algorithm (k-NN)
Kernel or Graph-based kernel PCA
low-dimensional embedding: using PCA, LDA, CCA, or NMF techniques as a pre-processing step followed by clustering by K-NN.

In more detail, the use of principal component analysis (PCA) and partial least squares (PLS) for processing and modeling complex data have been reported by Næs, T., et al., (Næs, T., et al., NIR Publications, (2002)). In WO 2009/086083 a method for hierarchically organizing data using PLS is reported. An analyzer and method for determining the relative importance of fractions of biological mixtures is reported in WO 2008/146059. In WO 2009/061326 the evaluation of chromatographic materials is reported

Maitra, S., and Yan, J., reviewed principle component analysis and partial least squares, which are two dimension reduction techniques for regression (Casualty Actuarial Society, 2008 Discussion Paper Program).

Principle component analysis (PCA) and partial least squares (PLS) are two established methods for the dimension reduction of complex data sets. These techniques are applied when the underlying data set comprises highly correlated independent variables. PCA does not reflect the correlations between the independent and dependent variables in the data set. In contrast, PLS is taking into account said correlation of dependent and independent variables. Thus, PCA is an unsupervised methodology, whereas PLS is a supervised methodology.

PCA is commonly used to reduce the number of predictive variables and solve the multi-co-linearity problem (Bair, E., et al., J. Am. Stat. Assoc. 101 (2006) 119-137). The advantage of PCA is that most of the information contained in the data set is retained. The data of the variables of the data set is combined in a limited number of linear combinations.

PCA can be done by any statistical software package. The statistical software generates Eigen vectors of the linear coefficients along with mean and standard deviations of each predictive variable. This is the basis for the calculation of the principle components by regression. That is, the principle components are obtained by Eigen-value decomposition of the covariance or correlation matrix of the predictive variables under consideration.

PCA relies on the X-vector or predictive variables. Especially, the relation of the predictive variables to the dependent or target variables is of no importance. Thus, PCA is an unsupervised technique. Thereby, most of the information contained in the raw predictive variables as well as in the relation between the predictive and target variables is retained.

In contrast to PCA, Partial least square is taking into account said correlation of dependent and independent variables and therefore is a supervised methodology. PLS is especially suited in cases wherein the predictive variables consist of many different measurements in an experiment and the relationships between these variables are ill understood (Kleinbaum, D. G., et al., in “Applied Regression Analysis and Multivariable Methods”, 3rd Edition (Pacific Grove, Ca, USA, Brooks/Cole Publishing Company, 1998).

In certain embodiments of the method according to the invention prior to PCA analysis physical information has to be removed by spectra pre-processing.

Moreover, the baseline shift can be eliminated by applying multiplicative scatter correction (MSC).

In order to enhance the variance between samples, in certain embodiments of the method according to the invention, the Savitzky-Golay filtering and smoothing method is applied. Optionally, spectra can be transformed to their first derivative.

The PCA analysis is performed in certain embodiments of the invention on the pre-processed spectra.

### The Method According to the Invention

The current invention is based, at least on part, on the finding that RAMAN spectroscopy in combination with statistical and machine learning/deep learning techniques can be used i) to detect low concentrations of full as well as empty particles of different AAV serotype capsids in aqueous buffer solutions, ii) to differentiate between full and empty particles in capsid samples, and iii) to differentiate between particles capsids of different serotype.

In further more detail, the current invention is based, at least on part, on the finding that conventional micro RAMAN spectroscopy in combination with principal component data analysis (PCA) can be used i) to detect low concentrations of full particles of the AAV2 and AAV8 serotype in aqueous buffer solutions, ii) to differentiate between full and empty particles in samples, and iii) to differentiate between particles of different serotype.

In general, recombinant AAV particles under evaluation and development for clinical applications are small, non-enveloped viral vectors with 20 to 25 nm in diameter and a recombinant single-stranded DNA genome of 14.7 kb (see FIG. 1). The two wild-type AAV gene encode for different rep and cap gene products by splicing, which are needed for viral replication and for formation of the capsid structure, respectively.

An AAV particle is on average composed of 74% protein and of 26% DNA by molecular weight. The maximum DNA payload capacity is 4.7 kb. Naturally occurring AAV capsids, as well as genetically engineered AAV capsids are under intensive evaluation in different studies and suitability tests for clinical applications. The AAV capsid amino acid sequences are highly conserved among different serotypes, ranging from 53% to >99% (see Table 2A of Vance, M., et al. in “Gene Therapy”, ed. by Doaa Hashad, InTechOpen, 2014, reproduced below as Table 1).

TABLE 1
Blast alignment of dual combination of AAV serotypes to determine percentage of homology.

| | AAV1 | AAV2 | AAV3 | AAV4 | AAV5 | AAV6 | AAV7 | AAV8 | AAV9 | AAV10 | AAV11 | AAV12 |
|---|---|---|---|---|---|---|---|---|---|---|---|---|
| AAV1 | 100% | 83% | 86% | 64% | 59% | 99% | 85% | 84% | 82% | 85% | 67% | 61% |
| AAV2 | 83% | 100% | 87% | 61% | 58% | 83% | 82% | 83% | 82% | 84% | 63% | 60% |
| AAV3 | 86% | 87% | 100% | 63% | 58% | 87% | 84% | 85% | 83% | 85% | 65% | 61% |
| AAV4 | 64% | 61% | 63% | 100% | 53% | 63% | 64% | 64% | 63% | 64% | 82% | 79% |
| AAV5 | 59% | 58% | 58% | 53% | 100% | 59% | 59% | 58% | 57% | 57% | 53% | 53% |
| AAV6 | 99% | 83% | 87% | 63% | 59% | 100% | 85% | 84% | 82% | 85% | 66% | 61% |
| AAV7 | 85% | 82% | 84% | 64% | 59% | 85% | 100% | 88% | 81% | 88% | 67% | 62% |
| AAV8 | 84% | 83% | 85% | 64% | 58% | 84% | 88% | 100% | 85% | 93% | 66% | 62% |
| AAV9 | 82% | 82% | 83% | 63% | 57% | 82% | 81% | 85% | 100% | 86% | 64% | 60% |
| AAV10 | 85% | 84% | 85% | 64% | 57% | 85% | 88% | 93% | 86% | 100% | 67% | 61% |
| AAV11 | 67% | 63% | 65% | 82% | 53% | 66% | 67% | 66% | 64% | 67% | 100% | 84% |
| AAV12 | 61% | 60% | 61% | 79% | 53% | 61% | 62% | 62% | 60% | 61% | 84% | 100% |

Studies with particles formed of naturally occurring AAV serotypes and of engineered capsid proteins revealed that even small differences in capsid protein amino acid sequence could affect tissue tropism of an AAV particle, and best, can be used to improve intended clinical applications. By this, a fast, non-invasive and sensitive analytical method is needed for the differentiation of particles of different AAV serotypes and for recombinant AAV particle quality control.

RAMAN spectroscopy is generally used to identify individual chemical components by detecting compound-specific vibrational responses of the comprised chemical bonds. The intensity of such a response is linearly correlated with the quantity of the respective bond in the analyte/sample.

The results from various conventional RAMAN spectroscopic studies (using visible or NIR excitation) in the literature shows that for certain bioprocess-relevant analytes, the limit of detection is between 0.50 mM and 2.0 mM. By this, a person skilled in the art would deem conventional RAMAN spectroscopy not applicable for the analysis of AAV particle containing relevant bioprocess samples, due to the (very) low concentrations and high molecular similarity of AAV particles of different serotype.

RAMAN spectroscopic approaches are known for quantification of intended compounds and analytes based on the concentration correlating spectrum characteristics, and relative peak intensities (Pelletier, M. J., Appl. Spectrosc., 57 (2003) 20A-42A; Ma, X., et al., Front. Chem., 6 (2018) Article 400). A significant benefit of this approach is the possibility to quantify specific analytes in complex matrices. In general, further following, but not limited to these, statistical and machine learning/deep learning methods for quantifying compounds based on RAMAN spectral data can be used:
linear algorithms, such as but not limited to
   PLS;
   lasso;
   lasso-lars;
   ridge regression;
   elastic net;
   Huber regression;
   passive aggressive regression;
   Bayesian ridge regression;
   orthogonal matching pursuit;
non-linear algorithms, such as but not limited to
   (artificial) neural networks (ANN);
   (nu) support vector regression;
   tree based algorithms: random forest regression, decision tree;
   boosting regression: XGBoost regression, gradient boosting regression, adaboost regression;
   autoML: autogluon, autokeras.

Partial Least Squares Regression (PLS): Partial least squares regression is a linear regression approach that finds a linear regression model by projecting the predicted and observed variables to a new space. As Lasso, it is a form of regularized linear regression where the number of components controls the strength of the regularization.

Lasso: Lasso (least absolute shrinkage and selection operator) is a linear regression approach that estimates sparse coefficients and consists of a linear model with an added regularization term. It is known to effectively reduce the number of features upon which the given solution is dependent.

Lasso Lars: Lasso Lars is a linear regression approach that uses the Least-angle regression (LARS) algorithm. LARS is a regression algorithm for high-dimensional data, which is similar to forward stepwise regression. It finds the features that correlate most with the target. It does not include all features at each step. The estimated coefficients are increased in a direction equiangular to each one's correlations with the residual.

Ridge Regression: Ridge regression is a linear regression approach. It solves a regression model where the loss function is the linear least squares function. The regularization is given by the 12-norm. Similar to the lasso regression, ridge regression introduces a penalty factor. However, ridge regression takes the square and not the magnitude of the coefficients as lasso regression.

Elastic net: Elastic net is a linear regression approach. It combines L1 and L2 priors as regularizers. This combination allows for learning a sparse model where few of the weights are non-zero like Lasso, while still maintaining the regularization properties of Ridge.

Huber Regression: Huber regression is a linear regression approach that is robust to outliers. It uses a different loss function rather than the traditional least squares method. For small residuals it is identical to the least squares penalty. On large residuals, however, the penalty is lower and increases linearly rather than quadratically.

Passive Aggressive Regressor: Passive aggressive regressor is a linear regression approach for large-scale learning and one of the few online-learning algorithms. This means that the algorithm is updated step-by-step. It is similar to the Perceptron and does not require a learning rate. Contrary to the Perceptron, a regularization parameter is included.

Bayesian Ridge Regression: Bayesian ridge regression is a linear regression approach. The statistical analysis is undertaken within the context of Bayesian inference. Thereby, it is assumed that errors are normally distributed and the prior distribution has a particular form. Explicit results are available for the posterior probability distributions of the model's parameters. The algorithm is similar to the classical Ridge regression.

Neural Networks: Neural networks are multi-layer perceptrons. The output of an artificial neuron is computed by some non-linear function of the sum of its input and might be inputs for another neuron. Here, up to 5 layers and up to 5 neurons per layer were used.

Nu Support Vector Regression: Nu support vector regression is a support vector regression with a new parameter, which determines the proportion of the number of support vectors that are desired to keep in the solution with respect to the total number of samples in the dataset.

Support Vector Regression: Support-vector machines construct a hyperplane or set of hyperplanes in a high-dimensional space. Decision Tree Regression: Decision Tree regression is a tree-based approach. The model predicts the value of a target variable by learning simple decision rules inferred from the data features. A tree can be seen as a piecewise constant approximation.

Random forest: Random forest is a tree-based approach. The number of classifying decision trees is fitted on various sub-samples of the dataset. Averaging is used to improve the accuracy of the prediction and to control overfitting.

Adaboost Regressor: Adaboost is a tree-based approach. A sequence of weak prediction models (i.e., models that are only slightly better than random guessing, such as small decision trees) are fitted on repeatedly modified versions of the data. The final prediction is then made by a weighted majority vote of all predictions.

Gradient Boosting Regressor: Gradient boosting is a tree-based approach. As Adaboost, the model is built in a stage-wise fashion, but it generalizes Adaboost and other boosting methods by allowing optimization of an arbitrary differentiable loss function.

Autogluon: Autogluon is an AutoML. The focus is on tree-based models, model ensembles, neural networks and linear models.

Autokeras: Autokeras is an efficient neural architecture search system. The focus is on neural networks.

In general, specific wavelength shifts can be assigned to nucleic acids and proteins in RAMAN spectroscopy. Some are summarized in Tables 2 to 4 below.

TABLE 2
Nucleic Acid (DNA/RNA) Analysis by Raman Spectroscopy - Common
bands assignments in ribose/phosphate/backbone (adopted from
Hobro, A.J., et al. Nucl. Acids Res. 35 (2007) 1169-1177)

| Raman Shift | |
|---|---|
| (cm⁻¹) | Assignment |
| 601 | Ribose |
| 813 | O—P—O symmetric stretching, marker for A-form helix |
| 856 | Ribose-phosphate |
| 919 | Ribose-phosphate, —C—O— stretching |
| 977 | Ribose-phosphate, —C—O— stretching |
| 1047 | P—O stretch, sugar phosphate —C—O— stretching |
| 1098 | PO₂⁻ symmetric stretching |
| 1136 | Stretching at 2′ position of ribose |

TABLE 3
DNA/RNA Analysis by Raman Spectroscopy - Common bands
assignments in bases (adopted from Hobro et al., supra).

| Raman Shift (cm⁻¹) | Assignment |
|---|---|
| 489 | G out of plane ring deformations |
| 580 | A/U/G/C out of plane ring deformations |
| 631 | A/U/G/C |
| 670 | G out of plane ring deformations |
| 726 | A ring stretching |
| 787 | C/U breathing/stretching |
| 876 | A/U/G/C out of plane ring deformations, backbone |
| 1182 | A/U/G/C ring; external C—N stretching |
| 1253 | U/C ring stretching |
| 1300 | C/A ring stretching |
| 1316 | A/G ring stretching |
| 1336 | A/G/U |
| 1380 | A/G/U |
| 1425 | A/G ring stretching, CH deformations |
| 1460 | U/C ring stretching, CH deformations |
| 1485 | A/G ring stretching/planar vibrations |
| 1532 | A/G/C ring stretching |
| 1578 | A/G ring stretching |

TABLE 4
Protein Analysis by Raman Spectroscopy - Common band
assignment in proteins (adopted from Beattie, J.R.,
et al., J. Raman Spec. 48 (2017) 813-821).

| Raman Shift | |
|---|---|
| (cm⁻¹) | Assignment |
| 510 | Cys-Cys stretch GGG conformation |
| 525 | Cys-Cys SS stretch. GGT conformation |
| 642-644 | Tyr |
| 661-670 | Cys C—S stretch |
| 750-752 | Trp |
| 820-830 with 850-860 | Tyr |
| 880-884 | Trp |
| 920-950 | CC stretch in a helix |
| 960 | CC stretch in random structure |
| 1000 | CC stretch in beta-sheet |
| 1003 | Phe ring breathing |
| 1032 | Phe, Tyr ring bending |
| 1050-1130 | C—C, C—N, C—O stretching modes |
| 1225-1235 | Amide III in beta-sheet |
| 1250-1255 | Amide III in random structure |
| 1265 | Amide III in globular a helix |
| 1305 | Amide III in fibrous a helix |
| 1408-1422 | COO⁻ |
| 1438 | COOH |
| 1450 | CH2 scissor (increases with |
| | hydrophilic interactions) |
| 1530-1630 | Phe, Tyr, His, Trp various ring modes |
| 1645-1658 | Amide I in a helix |
| 1660-1665 | Amide I in random structure |
| 1666-1680 | Amide I in beta-sheet |

The method according to the current invention employs micro RAMAN spectroscopy. Thereby most of the challenges for AAV particle analytics are overcome. The method according to the current invention is
non-invasive (native samples, no preparation needed);
fast (seconds to minutes);
multi-attribute approach with one sample/analysis (allows simultaneously for detection, identification, characterization, differentiation, quantification);
small sample volume demanding (e.g. 200 μL);
automatable (currently up to 96 samples in one sequence, 384 possible);
a stand-alone solution with a small lab footprint.

By the improved properties of the method according to the current invention
a reduced time for performing the analysis can be achieved (approx. 100-fold faster);
the analytical equipment landscape required can be reduced (approx. 2- to 4-fold reduced);
the throughput can be increased (allows for “unlimited” number of samples);
the representativeness can be increased (since non-invasiveness and no sample preparation required).

The method according to the current invention is exemplified in the following with commercially available AAV particle standards of the AAV2 and AAV8 serotype, each for particles with nucleic acid and without nucleic acid encapsidated. The samples were processed by the well-plate-based micro RAMAN system XPloRa Plus from Horiba. This is presented merely to exemplify the invention. It shall not be construed as a limitation. The true scope of the invention is set forth in the appended claims.

Samples comprising AAV viral particles with encapsidated nucleic acid payload are denoted as “full” (AAV2 or AAV8 full) herein whereas samples comprising AAV viral particles without encapsidated nucleic acid payload are denoted as “empty” (AAV2 or AAV8 empty) herein.

RAMAN spectra of AAV2 full and empty samples as well as their corresponding buffers were acquired 50 times each (50 repetitions) by an XPloRa Plus confocal RAMAN microscope. A laser with a wavelength of 532 nm was used. An exemplary overlay of the spectra is shown in FIG. 2.

RAMAN spectra of AAV8 full and empty samples as well as their corresponding buffer were acquired 5 times each (5 repetitions) by an XPloRa Plus confocal RAMAN microscope. A laser with a wavelength of 785 nm was used. An exemplary overlay of the spectra is shown in FIG. 3.

To allow a direct comparison between particles of the AAV2 and AAV8 serotype, the RAMAN spectra of AAV2 full and empty samples were acquired 5 times in addition using a laser wavelength of 785 nm.

In a first experiment, the feasibility of the method according to the current invention to distinguish between AAV2 full and AAV8 full samples, respectively, and buffer blank samples was shown. The viral particles were used at a concentration of 2*10\hat{ }13 vg/ml.

The results obtained for the AAV2 full sample are shown in FIG. 4. It can be seen that surprisingly the AAV2 full samples can be clearly distinguished from the blank buffer samples with the method according to the current invention. It can further be seen that the replicate full sample and blank buffer measurements cluster in distinct populations that are separated primarily by the first principal component (PC-1), which explains 55% of the variance in the data set. The other lower ranking PCA components, i.e. PC-2 and lower, do not contribute substantially at all, as can be seen in the PCA plot of FIG. 4, i.e. the second PC-2 does not contribute substantially to the separation of AAV2 vs. buffer control. PC-2 accounts only for 2% of the variance in the data set. All samples were measured by 532 nm laser wavelength excitation.

These results show that the method according to the current invention allows for the determination of viral particles with encapsidated nucleic acid by analysis of the PC-loadings. Thereby the important spectral features at specific RAMAN wavelength shifts that add to the population separation by each PC can be identified. It has been found that for the determination of AAV2 particles with encapsidated nucleic acid specific RAMAN shifts in the wavelength ranges of 489 to 728 cm-1 and 1645 to 1680 cm-1 can be used (see FIG. 5). Without being bound by this theory, it is assumed that the first shift region corresponds to nucleic acid, like, but not limited to, DNA/RNA specific nucleotide bond deformation and stretching vibrations and proteins, whereas the second shift region corresponds to the amide I bond stretches.

TABLE 5
Specific RAMAN wavelength shifts for the determination
of AAV2 particles with encapsidated nucleic acid.
Loadings AAV2 full vs buffer

| RAMAN Shift (cm⁻¹) | Assignment |
|---|---|
| 530 | V(S—S) disulfide in proteins |
| 565 | Polysaccharides |
| 665, 725, 785, 850 | DNA |
| 936 | Proteins vC—C alpha-helix |
| 1230, 1265 | Amide III |
| 1244 | RNA |
| 1671 | Amide I |

The results obtained for AAV8 full samples are shown in FIG. 6. It can be seen that surprisingly the AAV8 full samples can be clearly distinguished from the blank buffer samples with the method according to the current invention. It can further be seen, like for the AAV2 full samples, that the replicate measurements significantly cluster in distinct populations, which are separated by the first principal component PC-1, which explains 49% of the variance in the data set. The other lower ranking PCA components, i.e. PC-2 and lower, do not contribute substantially at all. It has been found that for the determination of AAV8 particles with encapsidated nucleic acid specific RAMAN shifts at the wavelengths of and in the wavelength ranges of, respectively, 551 cm-1, 645 cm-1, 1000 cm-1, 1003 cm-1, 1530-1630 cm-1, and 1645 to 1680 cm-1 can be used (see FIG. 7). Without being bound by this theory it is assumed that these correspond to protein-specific vibrations of the S-S Cys bridge (551 cm-1), Tyr-specific vibrations (645 cm-1), C-C stretch in beta-sheet (1000 cm-1), Phe-specific vibrations (1003 cm-1), Tyr specific vibrations (1530-1630 cm-1), and the amide I bond stretches (1645 to 1680 cm-1).

TABLE 6
Specific RAMAN wavelength shifts for the determination
of AAV8 particles with encapsidated nucleic acid.
Loadings AAV8 full vs buffer

| Raman Shift (cm⁻¹) | Assignment |
|---|---|
| 460 | Polysaccharides |
| 670, 747, 785 | DNA |
| 985 | Proteins vC—C beta-sheet |
| 1003 | Phenylalanine |
| 1080 | Nucleic acids |
| 1244 | RNA |
| 1613 | Tyrosine |
| 1671 | Amide I |

In a second experiment, the feasibility of the method according to the invention to distinguish between full and empty samples was evaluated. Therefore, AAV2 full and empty samples with a viral genome/particle concentration of 2*10\hat{ }13 vg/ml were used.

The results are shown in FIG. 8. It can be seen that surprisingly the full samples can be clearly distinguished from the empty samples with the method according to the current invention. It can further be seen that the replicate measurements cluster in distinct populations that are separated primarily by the first principal component PC-1, which explains 49% of the variance in the data set. The other lower ranking PCA components, i.e. PC-2 and lower, do not contribute substantially at all, as can be seen in the PCA plot of FIG. 8, i.e. the second PC-2 does not contribute substantially to the separation of full vs. empty samples. It has been found that for the discrimination of full and empty samples specific RAMAN shifts at the wavelengths of and in the wavelength ranges of, respectively, 551 cm-1, 645 cm-1, 631-787 cm-1, 1425-1485 cm-1, 1003 cm-1 and 1645 to 1680 cm-1 can be used (see FIG. 9). Without being bound by this theory it is assumed that these correspond to protein- and nucleic acid-specific vibrations of the S-S Cys bridge (551 cm-1), Tyr-specific vibrations (645 cm-1), nucleotide ring deformation and stretching (631-787 cm-1), A/G and U/C ring vibrations (1425-1485 cm-1), Phe-specific vibrations (1003 cm-1), and the amide I bond stretches (1645 to 1680 cm-1).

TABLE 7
Specific RAMAN wavelength shifts for the determination
of AAV2 particles with encapsidated nucleic acid in the
presence of AAV2 particles without encapsidated nucleic acid.
Loadings AAV2 full vs AAV2 empty

| Raman Shift (cm⁻¹) | Assignment |
|---|---|
| 530 | V(S—S) disulfide in proteins |
| 565 | Polysaccharides |
| 665, 725, 785 | DNA |
| 985 | Proteins vC—C beta-sheet |
| 1003 | Phenylalanine |
| 1265 | Amide III |
| 1671 | Amide I |

In a third experiment, the feasibility of the method according to the current invention to distinguish between different AAV serotypes was evaluated. Therefore, buffer background corrected AAV2 full sample and AAV8 full sample RAMAN spectra obtained at viral genome concentration of 2*10\hat{ }13 vg/ml were used. All samples were measured by 785 nm laser wavelength excitation.

The results obtained are shown in FIG. 10. It can be seen that surprisingly both AAV serotypes can be clearly distinguished with the method according to the current invention. It can further be seen that the replicate measurements cluster in distinct populations that are separated primarily by the first principal component PC-1, which explains 52% of the variance in the data set. The other lower ranking PCA components, i.e. PC-2 and lower, do not contribute substantially at all, as can be seen in the PCA plot of FIG. 10, i.e. the second PC-2 does not contribute substantially to the separation of full vs. empty samples. This was even more surprising in view of the low particle concentration and the overall high amino acid sequence homology of AAV8 with AAV2 with 83% (Lochire, M. A., et al., J. Virol. 80 (2006) 821-834). It has been found that for the discrimination of AAV particles of different serotype, such as AAV2 from AAV8, specific RAMAN shifts at the wavelengths of and in the wavelength ranges of, respectively, 551 cm-1, 645 cm-1, 920-950 cm-1, 1000 cm-1, 1003 cm-1, 1530-1630 cm-1, and 1645 to 1680 cm-1 can be used (FIG. 11).

TABLE 8
Specific RAMAN wavelength shifts for the determination
of AAV8 particles with encapsidated nucleic acid in the
presence of AAV2 particles with encapsidated nucleic acid.
Loadings AAV8 full vs AAV2 full

| Raman Shift (cm⁻¹) | Assignment |
|---|---|
| 460, 565, 855 | Polysaccharides |
| 665, 750, 825 | DNA |
| 936 | Proteins vC—C alpha-helix |
| 985 | Proteins vC—C beta-sheet |
| 1003 | Phenylalanine |
| 1080 | Nucleic acids |
| 1244 | RNA |
| 1450 | C—H vibration (proteins) |
| 1585 | Phenylalanine, Proteins |
| 1613 | Tyrosine |
| 1671 | Amide I |

Without being bound by this theory, it is assume that these correspond to protein-specific vibrations of the S-S Cys bridge (551 cm-1), Tyr-specific vibrations (645 cm-1), protein C-C stretch in helix structure (920-950 cm-1), C-C stretch in beta-sheet (1000 cm-1), Phe-specific vibrations (1003 cm-1), Tyr-specific vibrations (1530-1630 cm-1), and the amide I bond stretches (1645 to 1680 cm-1).

In a fourth experiment, the method according to the current invention was used to discriminate between full AAV particles of the serotypes 5, 8 and 9. Samples comprising full AAV particles of the different serotypes were measured by micro RAMAN spectroscopy. The obtained data was preprocessed (wave range: 400-1800 cm\hat{ }-1; SG-Filter 1st derivative, 1st polynoma, 25 pt, SNV transformation, a clear outlier was excluded) and analyzed by PCA. The results are shown in FIG. 12. It can be seen that a clear differentiation between the different serotypes is possible.

In a subsequent experiment, full and empty AAV particles of the serotypes 5, 8 and 9 were measured by micro RAMAN spectroscopy to show the applicability of the method according to the invention to differentiate between AAV serotype as well as AAV payload status. The obtained data was preprocessed (wave range: 400-1800 cm\hat{ }-1; SG-Filter 1st derivative, 1st polynoma, 25 pt, SNV transformation, a clear outlier was excluded) and analyzed by PCA. The most variances in the combined dataset for all serotypes are explained by PC1 (71%) and PC2 (16%). The results are shown in FIGS. 13 to 15. Thus, with the method according to the current invention full and empty AAV particles of AAV serotypes 5, 8 and 9 can be clearly separated.

To determine the limit of detection of the method according to the current invention, full and empty AAV particles of the serotype 2 were analyzed at four different concentrations (2E+13, 1E+13, 5E+12 and 2.5E+12 vg/mL). The obtained data was preprocessed (wave range: 400-1800 cm\hat{ }-1; SG-Filter 1st derivative, 1st polynoma, 25 pt, SNV transformation) and analyzed by PCA. The full and empty AAV particles are separated by PCA. The most variances in the combined dataset for all concentrations are explained by PC1 (29%) and PC2 (13%).

In FIGS. 19 to 22 the results for the separate analysis of the different concentrations are shown. Even at a concentration of 2.5E+12 vg/mL full and empty AAV particles cluster differently and can be identified by PCA despite the lower signal-to-noise ratio compared to other concentrations. The preprocessing results in an increased signal-to-noise ratio.

In summary and unexpectedly, the current invention is based on the unexpected finding that conventional RAMAN spectroscopy in combination with principal component data analysis can be used i) to detect low concentrations of AAV particles, such as AAV2 and AAV8 particles, with encapsidated nucleic acid in aqueous buffer solutions, ii) to differentiate between full and empty particle comprising samples, and iii) to differentiate between particles of different serotype. Thereby, the method according to the current invention is suitable for fast, non-invasive analysis of AAV particle containing samples, such as for, e.g., in-process control, quality assurance and control as well as (real-time) release analytics.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

All references mentioned herein are incorporated herewith in the entirety by reference.

The following examples and figures are provided to aid the understanding of the present invention, the true scope of which is set forth in the appended claims. It is understood that modifications can be made in the procedures set forth without departing from the spirit of the invention.

### DESCRIPTION OF THE FIGURES

FIG. 1 Molecular Features of AAVs. Naturally occurring and engineered AAV particles are composed of a non-enveloped icosahedral 60-mer protein capsid and a ˜4.7 kb viral single stranded DNA genome or recombinant gene payload. The small nm-sized particles are composed of 74% protein and 26% DNA in molecular weight.

FIG. 2 Overlay of RAMAN spectra for AAV2 samples acquired by an XPloRa Plus confocal RAMAN microscope; laser wavelength of 532 nm.

FIG. 3 Overlay of RAMAN spectra for AAV8 samples acquired by an XPloRa Plus confocal RAMAN microscope; laser wavelength of 785 nm.

FIG. 4 Detection of AAV2 particles by Micro RAMAN spectroscopy. Raman signals of full AAV2 particles and blank buffer samples can be distinguished. A Principal Component Analysis (PCA) was applied to RAMAN spectra of AAV 2 full and buffer blank samples. The RAMAN measurements of AAV2 full and buffer blank samples were repeated 50 times (n=50) in the same well. The scatter plot between PC-1 and PC-2 displays a separation between buffer blank (light gray) and AAV2 full (dark gray) sample spectra. The explained variance ratio of PC-1 is 55% and of PC-2 2%.

FIG. 5 Detection of AAV2 by Micro RAMAN spectroscopy-loadings. The first Principal Component (PC-1) can distinguish RAMAN signals of AAV2 full and buffer blank samples. The loadings of PC-1 show a clear distinction e.g. in the marked bands.

FIG. 6 Detection of AAV8 particles by micro RAMAN spectroscopy. RAMAN signals of full AAV8 particles and buffer blank samples can be distinguished. A Principal Component Analysis (PCA) was applied to RAMAN spectra of AAV8 full and buffer blank samples. The RAMAN measurements of AAV8 full and buffer blank samples were repeated 5 times (n=5) in the same well. The scatter plot between PC-1 and PC-2 displays a separation between buffer blank (light gray) and AAV8 full (dark gray) sample spectra. The explained variance ratio of PC-1 is 49% and of PC-2 10%.

FIG. 7 Detection of AAV8 particles by micro RAMAN spectroscopy-loadings. The first Principal Component (PC-1) can distinguish RAMAN signals of AAV8 full and buffer blank samples. The loadings of PC-1 show a clear distinction e.g. in the marked bands.

FIG. 8 Differentiation of full and empty AAV2 particles. RAMAN signals of AAV2 full and AAV2 empty samples can be distinguished. A Principal Component Analysis (PCA) was applied to RAMAN spectra of AAV2 full and AAV2 empty samples. The RAMAN measurements of AAV2 full and AAV2 empty samples were repeated 50 times (n=50) in the same well. The scatter plot between PC-1 and PC-2 displays a separation between AAV2 empty (light gray) and AAV2 full (dark gray) sample spectra. The explained variance of PC-1 is 49% and of PC-2 4%.

FIG. 9 Differentiation of full and empty AAV2 particles-loadings. The first Principal Component (PC-1) can distinguish Raman signals of AAV2 full and AAV2 empty samples. The loadings of PC-1 show a clear distinction e.g. in the marked bands.

FIG. 10 Differentiation of AAV particle serotypes. RAMAN signals of AAV2 full and AAV8 full samples can be distinguished. A Principal Component Analysis (PCA) was applied to RAMAN spectra of AAV2 full and AAV8 full samples. The RAMAN measurements of AAV2 full and AAV8 full samples were repeated 5 times in the same well. The scatter plot between PC-1 and PC-2 displays a separation between AAV8 full (dark gray) and AAV2 full (light gray) sample spectra. The first component shows an explained variance ratio of 52% and the second component of 8%.

FIG. 11 Differentiation of AAV particle serotypes-loadings. The first Principal Component (PC-1) can distinguish RAMAN signals of AAV2 full and AAV8 full samples. The loadings of PC-1 show a clear distinction e.g. in the marked bands.

FIG. 12 Differentiation by PCA of AAV5, AAV8 and AAV9 full capsids by micro RAMAN spectroscopic analysis. For each serotype, spectra were acquired in two different wells with five replicates each. Also shown are the loadings for PC1 and PC2 for the differentiation of AAV5, AAV8 and AAV9 full capsids by micro RAMAN spectroscopic analysis.

FIG. 13-15 Differentiation of full (white circles) and empty (black circles) capsids by PCA for AAV5 (FIG. 13), AAV8 (FIG. 14), AAV9 (FIG. 15, outlier cleared dataset), and the corresponding loadings for PC1 and PC2 using micro RAMAN spectroscopic analysis.

FIG. 16-18 PCA for the differentiation of gradual mixtures of AAV empty with AAV full particles by micro RAMAN spectroscopic analysis. Also shown are the loadings for PC1 and PC2 for the differentiation of gradual mixtures of AAV empty with AAV full particles by micro RAMAN spectroscopic analysis. FIG. 16 (AAV9), FIG. 17 (AAV5, full dataset), FIG. 18 (AAV5, outlier cleared dataset).

FIG. 19-22 Differentiation of full and empty AAV particles by PCA at four different concentrations using micro RAMAN spectroscopic analysis.

FIG. 19: 2E+13 vg/mL; FIG. 20: 1E+13 vg/mL; FIG. 21: 5E+12 vg/mL; FIG. 22: 2.5E+12 vg/mL.

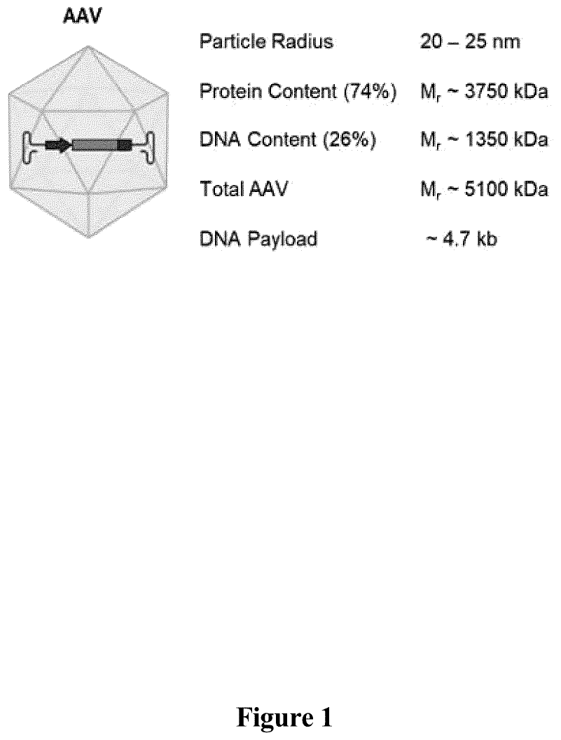

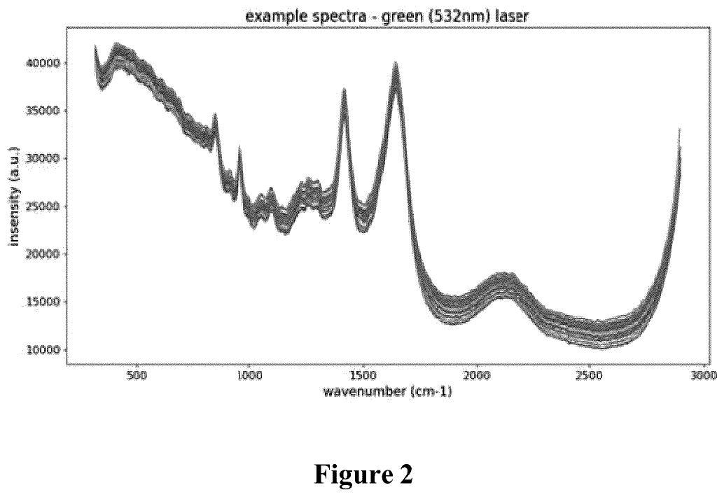

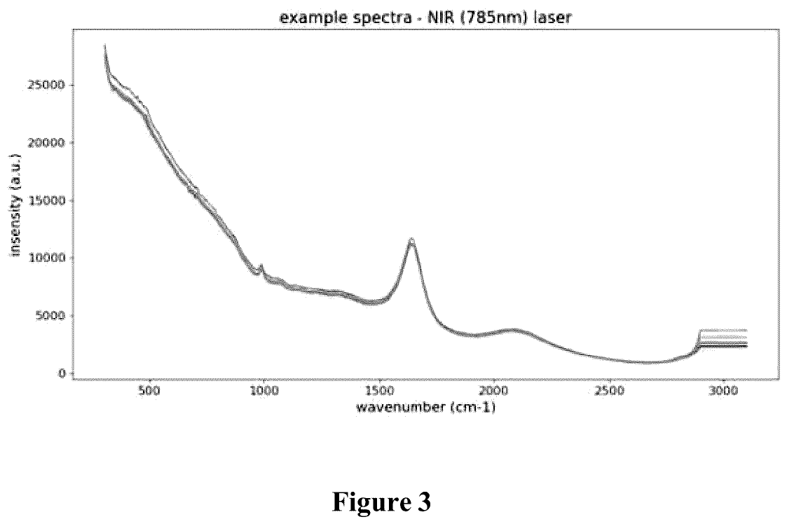

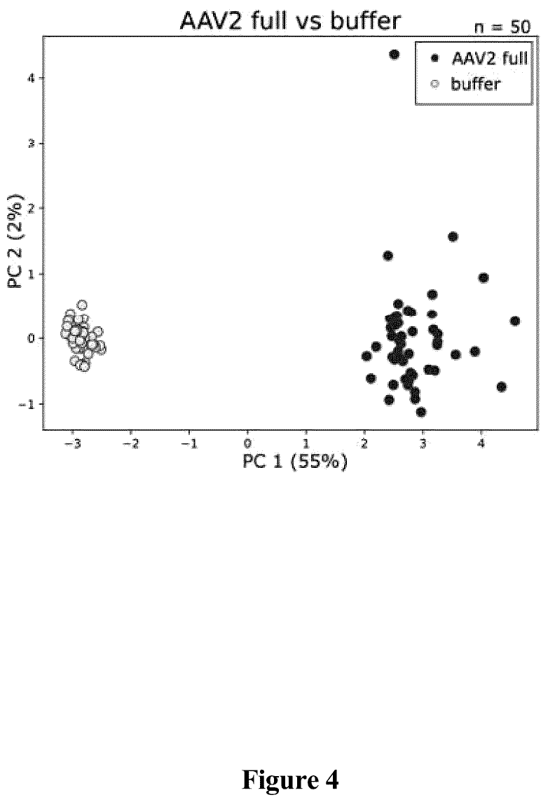

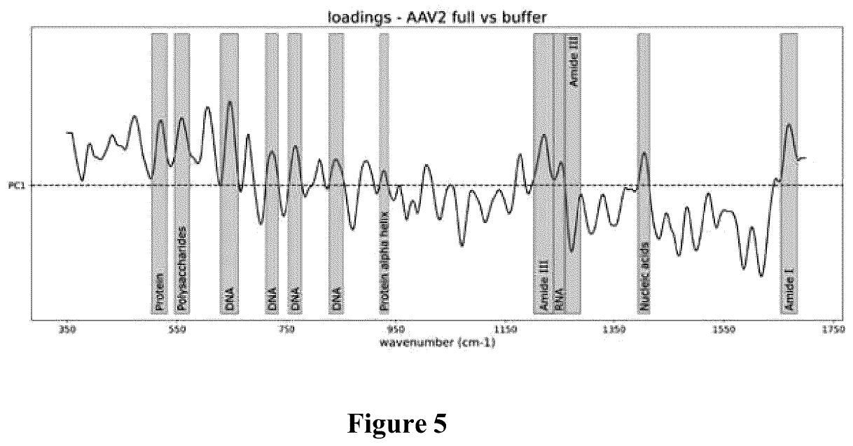

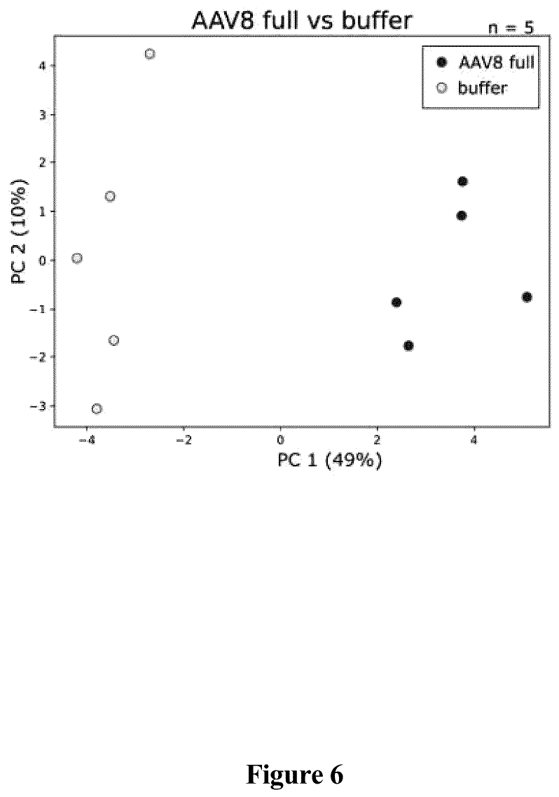

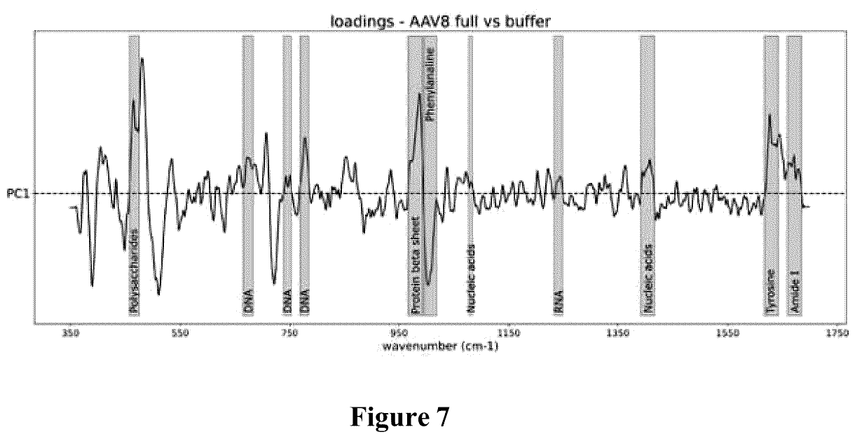

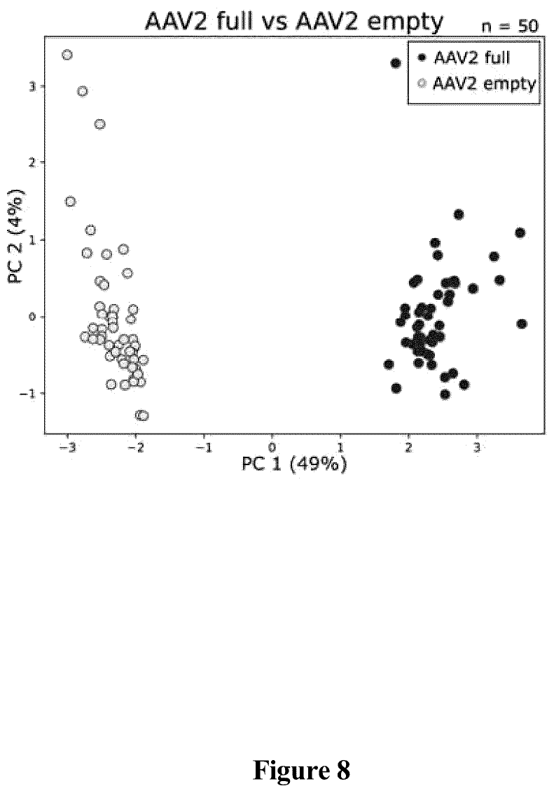

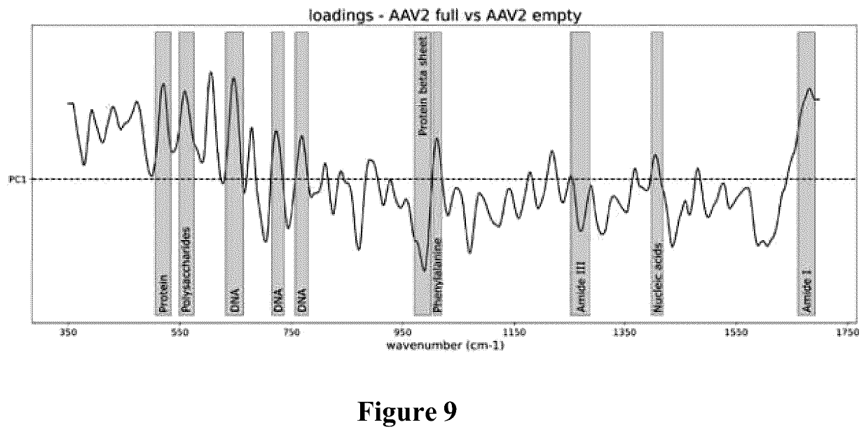

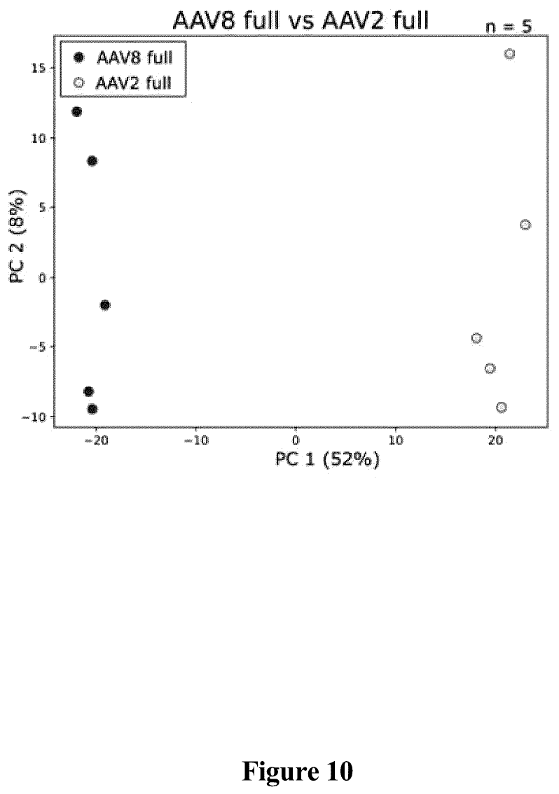

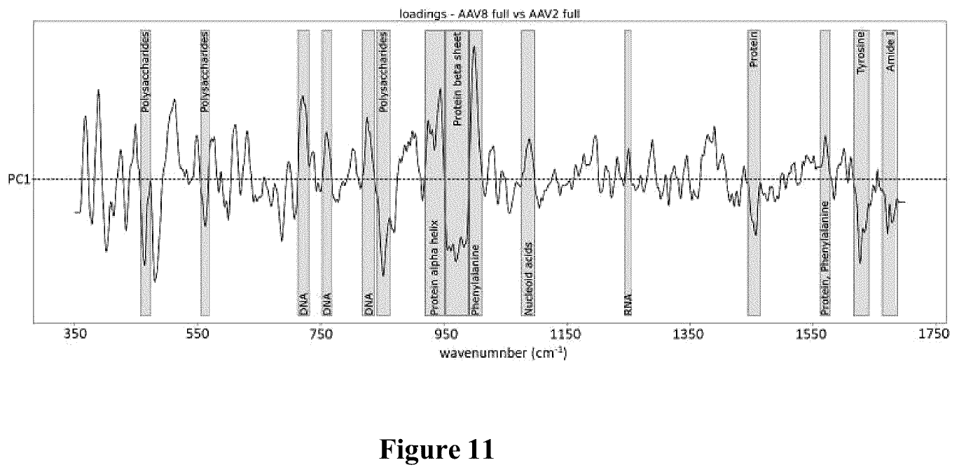

### EXAMPLES

### Material and Methods

All measurements were performed using the XPloRa Plus confocal RAMAN microscope (Horiba, Longjumeau, France). As sample holder, the commercially available SensoPlate (Greiner Bio-One GmbH, Kremsmuenster, Austria) was used. The AAV containing samples were commercially available standards by Virovek (Hayward, USA) with a virus concentration of 2E+13 vg/mL.

### Data Analysis

To compare AAV2 full and AAV8 full the RAMAN spectra of samples of AAV2 full, AAV8 full and the corresponding buffers without AAV particles were recorded five times. Thereafter, all spectra were scaled by a min-max scaler and the mean buffer spectra subtracted from the corresponding AAV sample spectra. In this way, the background was removed and the spectra of AAV2 full and AAV8 full were comparable. In a next step, the spectra were preprocessed as follows: 1.) elimination of wavenumbers outside the fingerprint region; 2.) application of Savitzky-Golay filter; 3.) normalization of the spectra. In a last step a principal component analysis (PCA) was performed with two components and the loadings were plotted.

For samples of AAV2 full and buffer as well as for samples of AAV2 full and AAV2 empty the RAMAN spectrum of each sample was determined 50 times. For samples of AAV8 full and buffer only samples the RAMAN spectrum of each sample was determined 5 times. The spectra were preprocessed as follows: 1.) elimination of wavenumbers outside the fingerprint region; 2.) application of Savitzky-Golay filter; 3.) normalization of the spectra. In a last step a principal component analysis (PCA) was performed with two components and the loadings were plotted. Following PCs, such as PC3 and following PCs (e.g. PC4, PC5 . . . ) have no significant contribution to explain the observed effects. The explained variance of following PCs is always smaller than the explained variance of PC2.

### Serotype Differentiation

Different “full” AAV capsids for serotypes 5, 8 and 9 were measured by micro RAMAN spectroscopy in two different wells, 5 times per well. For the measurement, the settings as described below were used. One measurement of AAV5 was considered an outlier probably due to an analytical artifact and excluded. The data was preprocessed as outlined below and analyzed by PCA.
Measurement Settings: Laser wavelength 532 nm, acquisition: 2×20s, ND 100, 250-3000 cm\hat{ }-1, ×10 objective, SS-MWP (stainless steel micro well plate)
Preprocessing: Wave range: 400-1800 cm\hat{ }-1; SG-Filter Ist derivative, 1st polynoma, 25 pt, SNV transformation

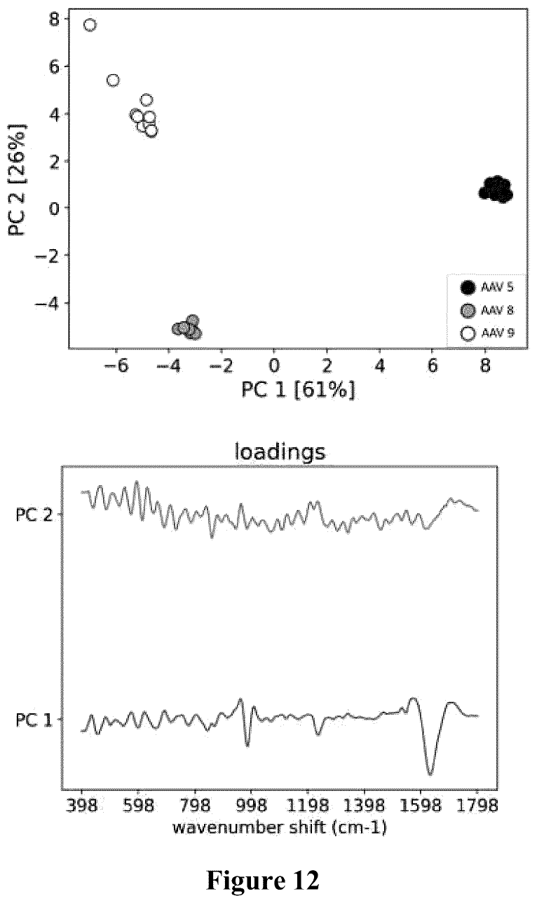

The results are shown in FIG. 12.

### Full/Empty Differentiation

Full and empty AAV particles of the serotypes 5, 8 and 9, were measured by micro RAMAN spectroscopy. For the measurement, the same settings as for the serotype determination were used (see below). One measurement of AAV9 full was considered an outlier and excluded. The data was preprocessed as outlined below and analyzed by PCA.

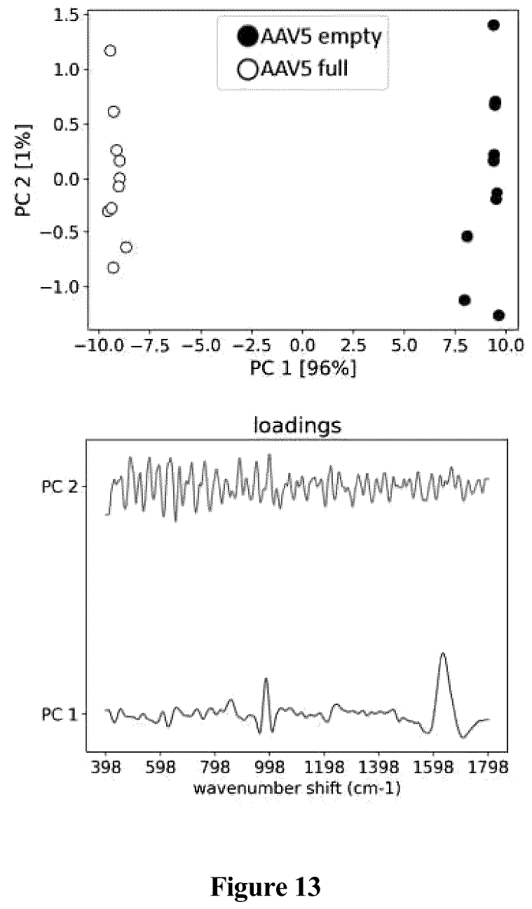

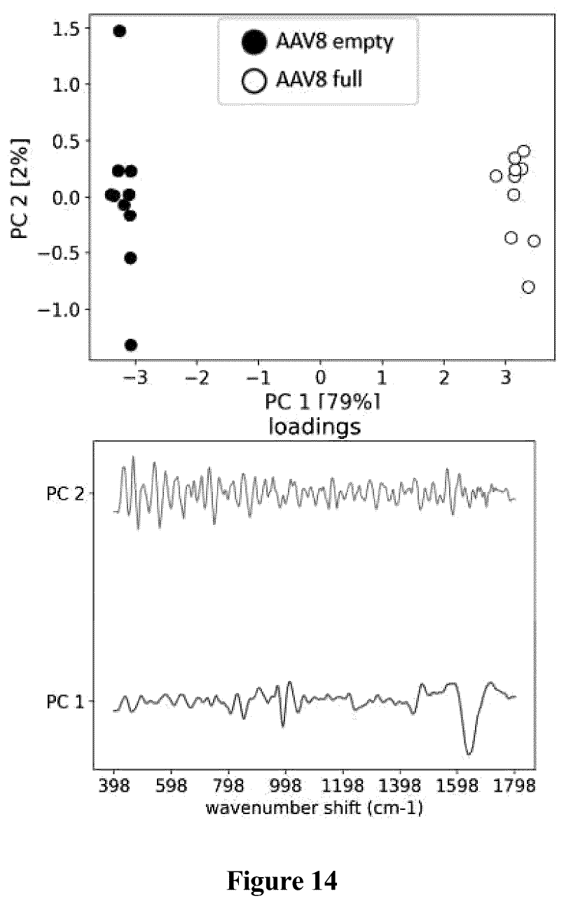

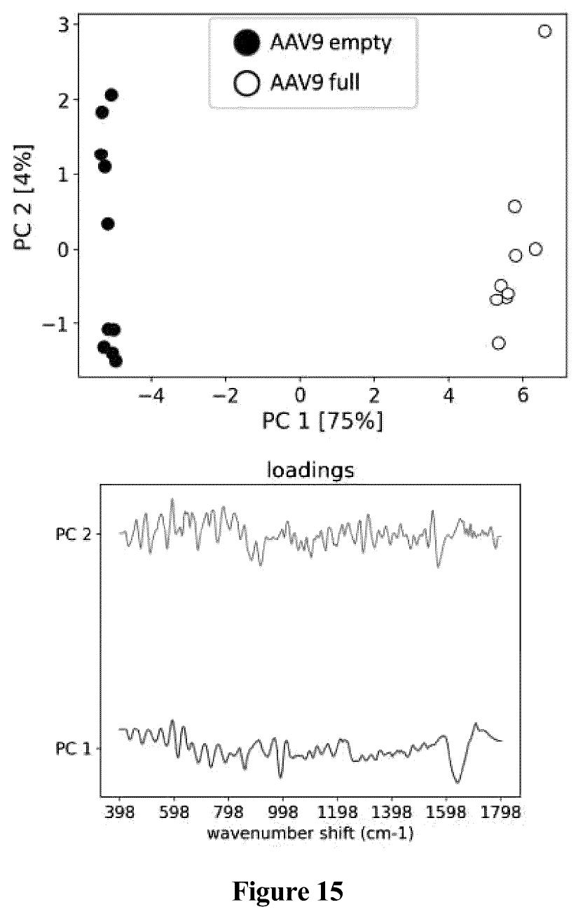

The results are shown in FIGS. 13 (AAV5), 14 (AAV8) and 15 (AAV9, outlier cleared dataset).

The full and empty AAV particles of serotypes 5, 8 and 9 can clearly be separated in the combined dataset by PC1 (71%) and PC2 (16%).
Measurement Settings: Laser wavelength 532 nm, acquisition: 2×20s, ND 100, 250-3000 cm\hat{ }-1, ×10 objective, SS-MWP
Preprocessing: Wave range: 400-1800 cm\hat{ }-1; SG-Filter 1st derivative, 1st polynoma, 25 pt, SNV transformation

### Identification of Mixtures of Full and Empty Capsids

In order to characterize the gradual increase of full AAV particles in a matrix of empty AAV particles, the respective standards were sonicated and mixed.

The measurement was performed as follows:
measurement of 5 replicates of 30 μL empty standard in two wells each;
addition of 5 μL of full standard to both wells, resuspend and repeat measurement of 5 replicates (5 μL in total/well);
adding of a further 5 μL of full standard to both wells, resuspend and repeat measurement of 5 replicates (10 μL in total/well);
adding of a further 5 μL of full standard to both wells, resuspend and repeat measurements of 5 replicates (15 μL in total/well);
measurement of 5 replicates 30 μL full standard in two wells each.

The settings as described below were used. The data was preprocessed as described below and analyzed by PCA.

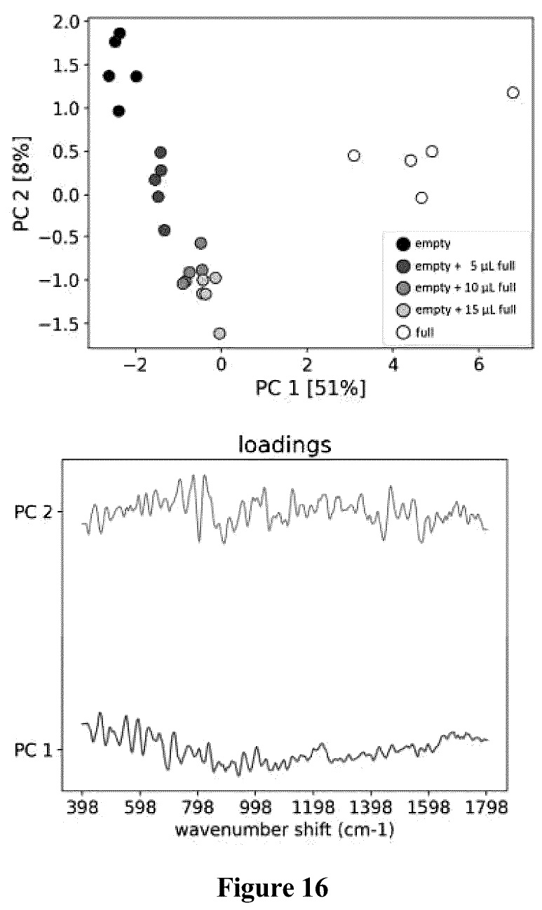

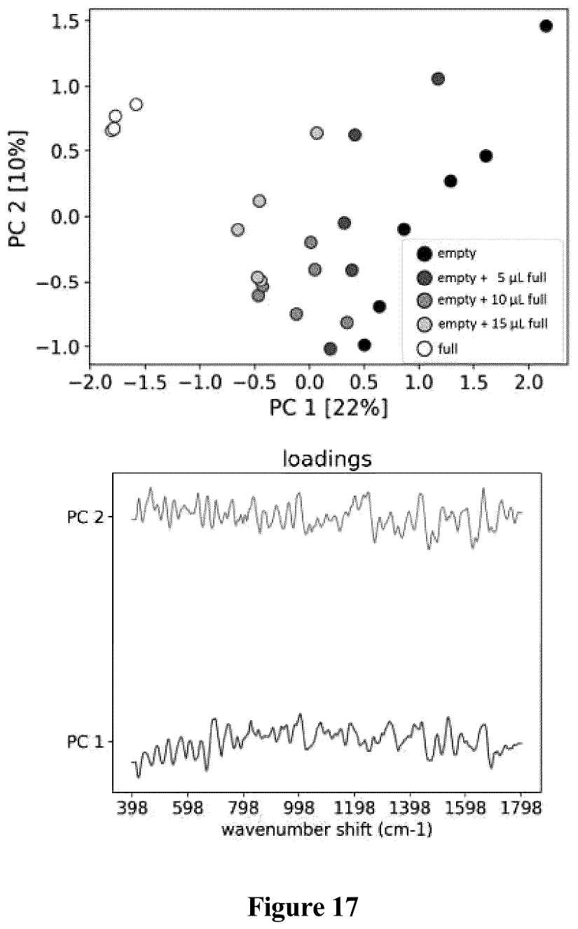

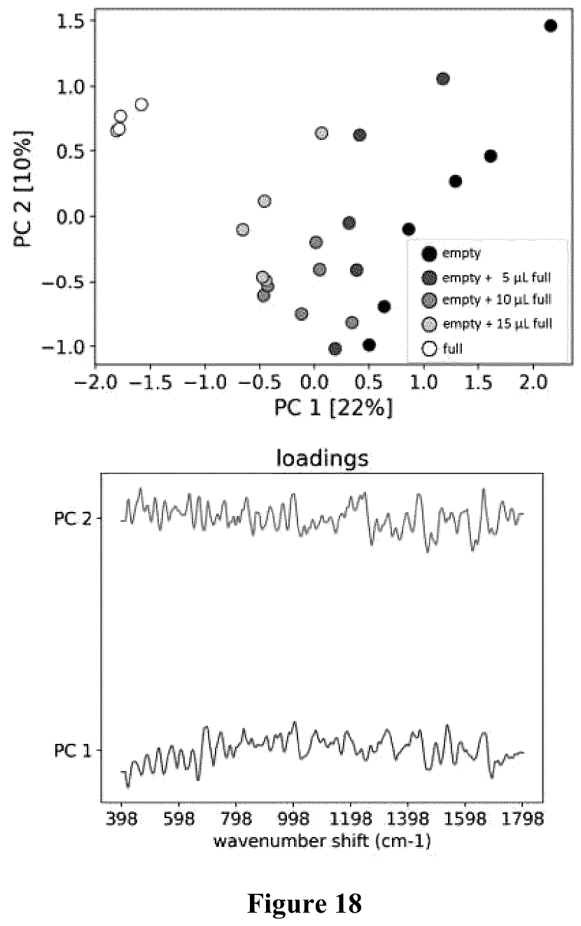

The results are shown in FIG. 16 (AAV9), 17 (AAV5) and 18 (AAV5, outlier cleared dataset).

The full (white circles) and empty (black circles) AAV particles can be clearly separated. A gradual increase of AAV full into the AAV empty standard, by adding in sum 5 μL, 10 μL and 15 μL of the full AAV standard, was clearly observable by the shifting of the respective clusters (replicates) in PCI and PC2 (light, middle and dark gray circles). For the combined dataset the most variances were explained by PC1 (51% and 30%, with and without outlier respectively) and PC2 (8% and 13%, with and without outlier respectively).

For one replicate of AAV5 empty with 15 μL AAV5 full and for one replicate of AAV5 with 5 μL AAV5 full, a clear shift towards PCI or PC2 was observed. The shifts were deemed to originate most probably from an analytical artifact. For an analysis of the PCA separation without consideration of these two outliers, a new PCA was generated. By this, the gradual increase of AAV5 full into the AAV5 empty standard, by adding in sum 5 μL, 10 μL and 15 μL of the full AAV standard, was even more clearly observable by shifting the clusters (replicates) in PC1 and PC2 (light, middle and dark gray circles). Again, the most variances were explained by PC1 (22%) and PC2 (10%).
Measurement Settings: Laser wavelength 532 nm, acquisition: 2×20s, ND 100, 250-3000 cm\hat{ }-1, ×10 objective, SS-MWP
Preprocessing: Wave range: 400-1800 cm\hat{ }-1; SG-Filter 1st derivative, 1st polynoma, 27 pt, SNV transformation:

### Full/Empty Differentiation at Different AAV Concentrations

To determine the limit of detection for the determination of the DNA payload status, AAV2 full and empty particles were measured at four different concentrations (2E+13, 1E+13, 5E+12 and 2.5E+12 vg/mL) in two different wells with five replicates for each well. The settings as outlined below were used. The data was preprocessed as outlined below and all concentrations were analyzed together by PCA. The most variances were explained by PC1 (29%) and PC2 (13%).

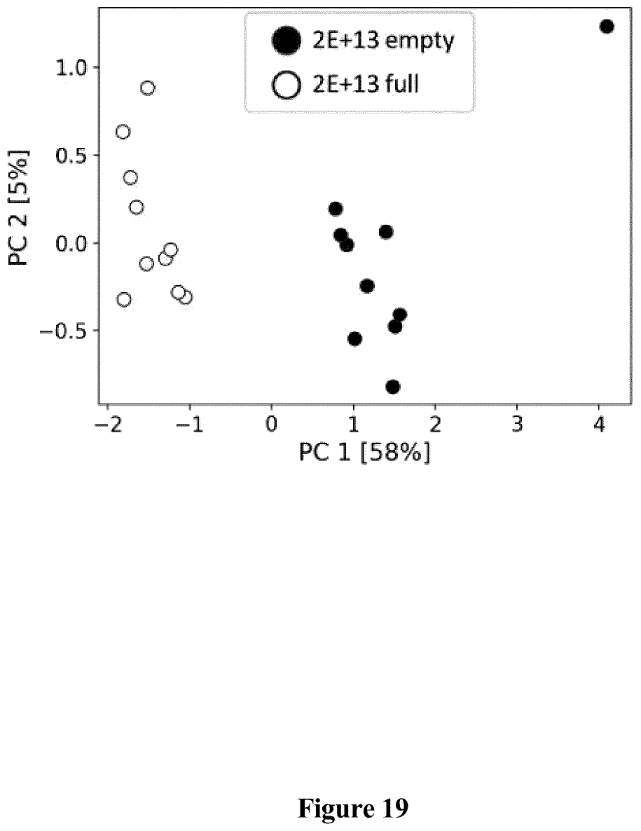

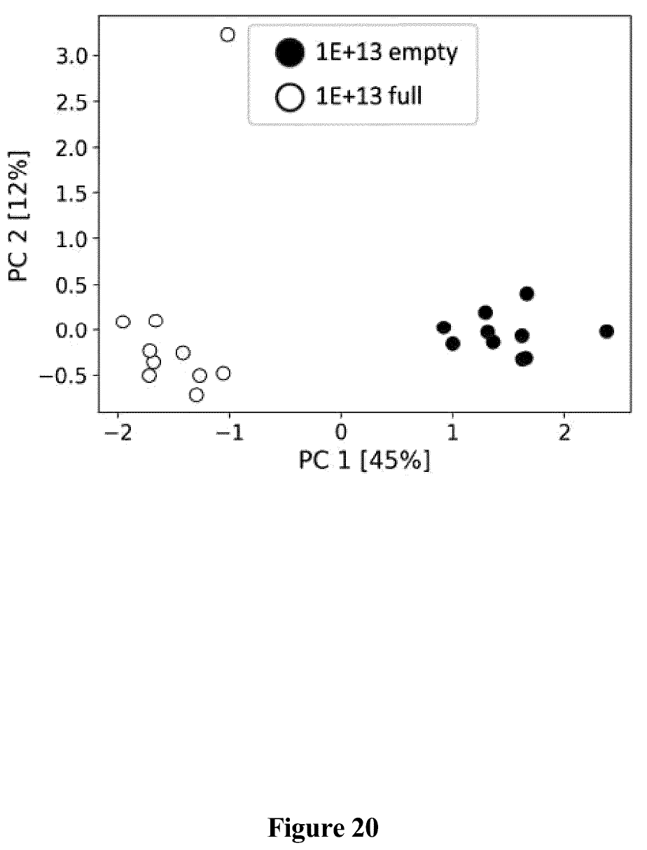

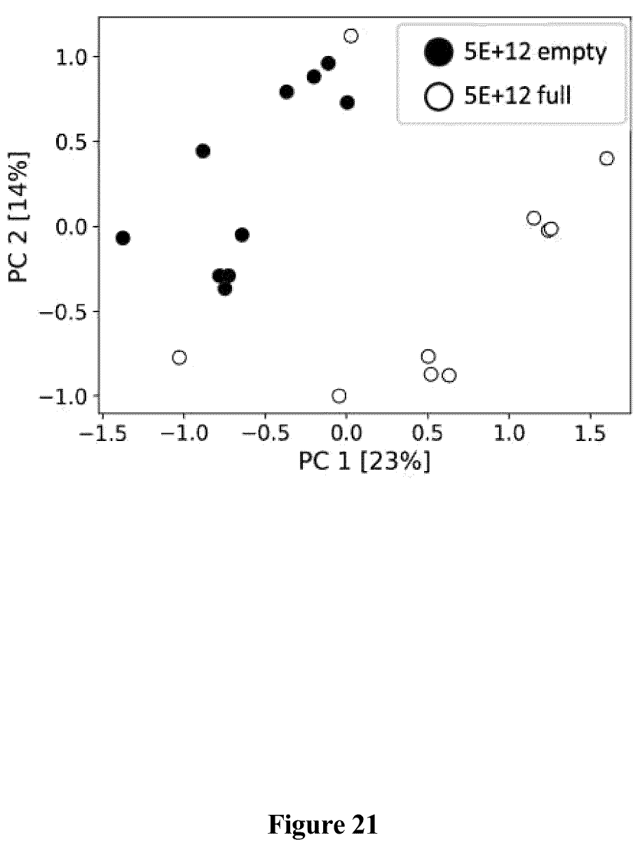

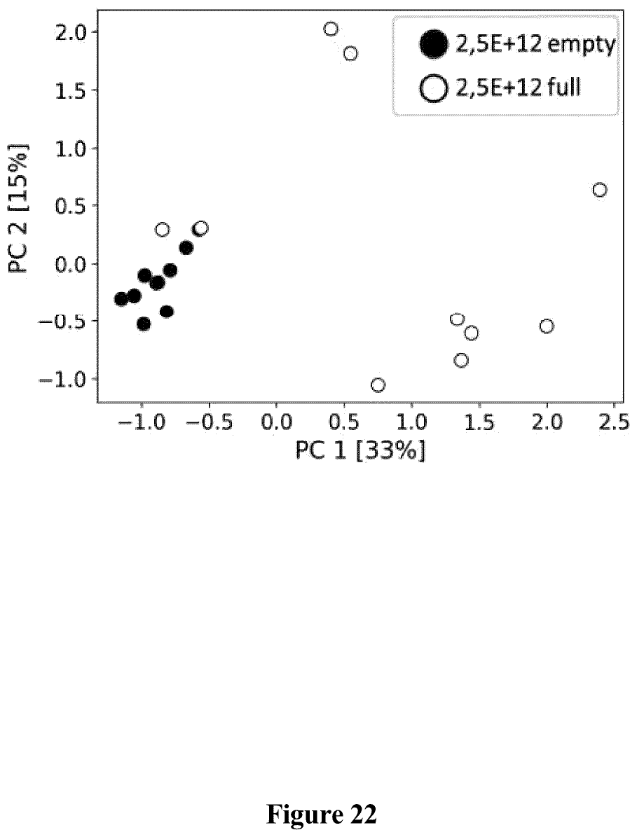

The concentrations were also analyzed separately by PCA. FIGS. 19-22 present the individual results for the different concentrations. Even at a concentration of 2.5E+12 vg/mL full and empty particles cluster differently and can be determined.
Measurement Settings: Laser wavelength 532 nm, acquisition: 2×20s, ND 100, 250-3000 cm\hat{ }-1, 600 gr/mm, ×10 objective, SS-MWP
Preprocessing: Wave range: 400-1800 cm\hat{ }-1; SG-Filter Ist derivative, 1st polynoma, 27 pt, SNV transformation.

1. A method for determining in an aqueous sample using RAMAN spectroscopy viral particles with encapsidated nucleic acid comprising the steps of:
(a) providing a sample and irradiating the sample with a light source;
(b) (i) measuring the total intensity of RAMAN scattered light of the sample or of at least each one of a first plurality of pre-selected wavenumbers and/or wavenumber ranges to obtain a first data set for the sample;
(ii) performing a principal component analysis on the first data set; and
(c) determining the viral particles with encapsidated nucleic acid in the sample based upon the output of the first set of mathematical data processing steps,
wherein the viral particles are in solution.

2. The method according to claim 1, wherein the viral particles with encapsidated nucleic acid are determined based upon the first principal component.

3. The method according to claim 1, wherein the step (i) comprises
(alpha) measuring the total intensity of RAMAN scattered light of the sample, (beta) elimination of wavenumbers outside of a first plurality of pre-selected wavenumbers and/or wavenumber ranges,
(gamma) generating the 1st deviation of the data function, and
(delta) normalizing the spectra,
to obtain a first data set for the sample.

4. The method according to claim 3, wherein the generating the 1st deviation of the data function is by applying a Savitzky-Golay filter.

5. The method according to claim 1, wherein the RAMAN scattered light is determined using a confocal RAMAN microscope or micro RAMAN spectroscopic device.

6. The method according to claim 1, wherein the sample is a crude sample/is not pre-treated.

7. The method according to claim 1, wherein the viral particle is an adeno-associated viral particle.

8. The method according to claim 1, wherein the viral particle is an adeno-associated viral particle of the serotype 2 or 8.

9. The method according to claim 1, wherein the viral particle is an AAV particle of the serotype 2 and the light source has a wavelength of about 532 nm or about 785 nm.

10. The method according to claim 1, wherein the viral particle is an AAV particle of the serotype 8 and the light source has a wavelength of about 785 nm.

11. The method according to claim 1, wherein the first plurality of pre-selected wavenumbers and/or wavenumber ranges is consisting of 489 to 728 cm-1 or/and 1645 to 1680 cm-1.

12. The method according to claim 1, wherein the first plurality of pre-selected wavenumbers and/or wavenumber ranges is consisting of one or more or all of 551 cm-1, 645 cm-1, 1000 cm-1, 1003 cm-1, 1530-1630 cm-1, or/and 1645 to 1680 cm-1.

13. The method according to claim 1, wherein the first plurality of pre-selected wavenumbers and/or wavenumber ranges is consisting of one or more or all of 551 cm-1, 645 cm-1, 631-787 cm-1, 1425-1485 cm-1, 1003 cm-1, or/and 1645 to 1680 cm-1.

14. The method according to claim 1, wherein the first plurality of pre-selected wavenumbers and/or wavenumber ranges is consisting of one or more or all of 551 cm-1, 645 cm-1, 920-950 cm-1, 1000 cm-1, 1003

15. Use of RAMAN spectroscopy in combination with mathematical analysis or mathematical processing of the total intensity of RAMAN scattered light of the sample or of at least each one of a first plurality of pre-selected wavenumbers and/or wavenumber ranges for the in solution determination of viral particles with encapsidated nucleic acid in an aqueous sample.
